(19) United States
(12) Patent Application Publication
(10) Pub. No.: US 2025/0004227 A1
(43) Pub. Date: Jan. 2, 2025

(54) ADAPTERS FOR HETEROGENOUS OPTICAL CONNECTORS

(71) Applicant: Intel Corporation, Santa Clara, CA (US)

(72) Inventors: Wesley B. Morgan, Lake Oswego, OR (US); Sufi R. Ahmed, Chandler, AZ (US)

(73) Assignee: Intel Corporation, Santa Clara, CA (US)

(21) Appl. No.: 18/217,165

(22) Filed: Jun. 30, 2023

(51) Int. Cl. G02B 6/42

(52) U.S. Cl. CPC G02B 6/4293; G02B 6/423; G02B 6/4243; G02B 6/4283; G02B 6/4214

(57) ABSTRACT

Embodiments of optical adapters, and methods of forming and using the same, are disclosed herein. In one example, an optical adapter includes a first interface to mate with a first optical connector, a second interface to mate with a second optical connector, and a plurality of waveguides extending through the optical adapter from the first interface to the second interface. The first interface includes a first set of alignment features to align the optical adapter with the first optical connector, and the second interface includes a second set of alignment features to align the optical adapter with the second optical connector. Further, when the first interface is mated with the first optical connector and the second interface is mated with the second optical connector, the first and second optical connectors are optically coupled via the waveguides.

### BACKGROUND

High-speed optical interconnects are crucial to meet the continuously increasing data rate demands of modern data centers and computing systems. For example, traditional computing components can be packaged with optical interfaces to enable them to communicate over high-speed optical interconnects rather than traditional electrical interconnects. Optical interconnects are typically implemented using fiber cables, which contain bundles of glass fibers for carrying optical signals. In some cases, fiber cables may be connected to optical interfaces using pluggable optical connectors. There are a variety of heterogenous optical connectors available in the industry, however, and many of them are incompatible with each other. As a result, some fiber cables and optical interfaces are incompatible and cannot be used together.

### BRIEF DESCRIPTION OF THE DRAWINGS

FIGS. 1A-D illustrate an example of an optical connection between a photonic integrated circuit (PIC) and an incompatible fiber cable using an optical adapter.

FIGS. 2A-C illustrate an example embodiment of an adapter for connecting an incompatible fiber cable to a PIC.

FIGS. 3A-B illustrate another example embodiment of an adapter for connecting an incompatible fiber cable to a PIC.

FIGS. 4A-B illustrate an example embodiment of an adapter holder for an adapter used to connect an incompatible fiber cable to a PIC.

FIGS. 5A-C illustrate an example of an optical connection between heterogenous fiber cables using an optical adapter.

FIGS. 6A-D illustrate an example embodiment of an adapter for connecting heterogenous fiber cables.

FIGS. 7A-C illustrate an example embodiment of an adapter holder for an adapter used to connect heterogenous fiber cables.

FIG. 8 illustrates a process flow for forming and using an optical adapter assembly.

FIGS. 9A-B illustrate an example embodiment of an optical package in accordance with certain embodiments.

FIG. 10 is a top view of a wafer and dies that may be included in a microelectronic assembly, in accordance with any of the embodiments disclosed herein.

FIG. 11 is a cross-sectional side view of an integrated circuit device that may be included in a microelectronic assembly, in accordance with any of the embodiments disclosed herein.

FIG. 12 is a cross-sectional side view of an integrated circuit device assembly that may include a microelectronic assembly, in accordance with any of the embodiments disclosed herein.

FIG. 13 is a block diagram of an example electronic device that may include a microelectronic assembly, in accordance with any of the embodiments disclosed herein.

### DETAILED DESCRIPTION

High-speed optical interconnects are crucial to meet the continuously increasing data rate demands of modern data centers and computing systems. For example, traditional computing components (e.g., processors, accelerators, FPGAs, switches, memory/storage, other ASIC nodes) can be packaged with optical interfaces to enable them to communicate over high-speed optical interconnects rather than traditional electrical interconnects. Optical interconnects are typically implemented using fiber cables, which contain bundles of glass fibers for carrying optical signals (e.g., light or laser beams).

In some cases, fiber cables may be connected to optical interfaces using pluggable optical connectors. For example, a fiber cable may include an optical plug designed to mate with a corresponding optical socket on an optical interface. There are a variety of heterogenous optical connectors available in the industry, however, and many of them are incompatible with each other. As a result, some fiber cables and optical interfaces are incompatible and cannot be used together.

Accordingly, this disclosure presents embodiments of optical adapters for heterogenous optical connectors/ferrules, which can be used to optically couple photonic modules and/or fiber cables that are otherwise incompatible. In particular, the described embodiments include (i) adapters to optically couple photonic modules to incompatible fiber cables and (ii) adapters to optically couple multiple incompatible fiber cables.

For example, the described embodiments include a glass-coupler-to-mechanical transfer (MT)-ferrule adaptor to optically couple a photonic module with a glass coupler to a fiber cable with a standard MT ferrule. This adapter provides inter-compatibility between standard MT ferrules such as those found on fiber cables and glass-based optical couplers such as those used to connect to photonic integrated circuits (PICs). In some embodiments, for example, the adapter may be a two-sided short optical jumper, where one side has features to mate with an optical coupler on a PIC module using the on-package alignment and retention features designed for the particular glass-based optical coupling system used by the optical coupler, and the opposite side has pin alignment features and housing to receive an industry standard optical fiber MT connector.

The described embodiments also include a glass-ferrule-to-MT-ferrule adaptor to optically couple a fiber cable with a glass ferrule to a fiber cable with a standard MT ferrule. For example, this adapter may be used to connect the glass-ferrule-end of a fiber ribbon cable assembly (which may be connected to a PIC glass-based coupler on the other end) to a standard MT ferrule to provide compatibility with readily available standard MT-ferrule-type ribbon cable assemblies and jumpers, including for debug and troubleshooting purposes. In some embodiments, for example, the adapter may be a two-sided adapter, where one side has standard MT ferrule pin receptacle features, and the opposite side has glass-based fiber ferrule type alignment features. In this manner, a glass-based fiber ferrule originally designed to mate with an on-package receptacle/socket on a glass-based coupler can be connected instead to a standard MT fiber ferrule.

These embodiments provide various advantages. For example, industry standard fiber ferrules, such as mechanical transfer (MT) ferrules, are poorly suited for attachment to photonics packaging due to their relatively large size, along with their material coefficient of thermal expansion (CTE) and reflow compatibility. Further, as new types of optical connectors are developed for photonics packaging, the latest optical connectors may not be readily available for some time and may be incompatible with MT-ferrule-based cables. Thus, the described adapters provide an alternative connection type for new optical connectors to enable compatibility or interchangeability with industry standard and widely available cable assemblies, such as MT-ferrule-based fiber cables. Further, the described adapters are also useful for assembly/test setups and troubleshooting scenarios.

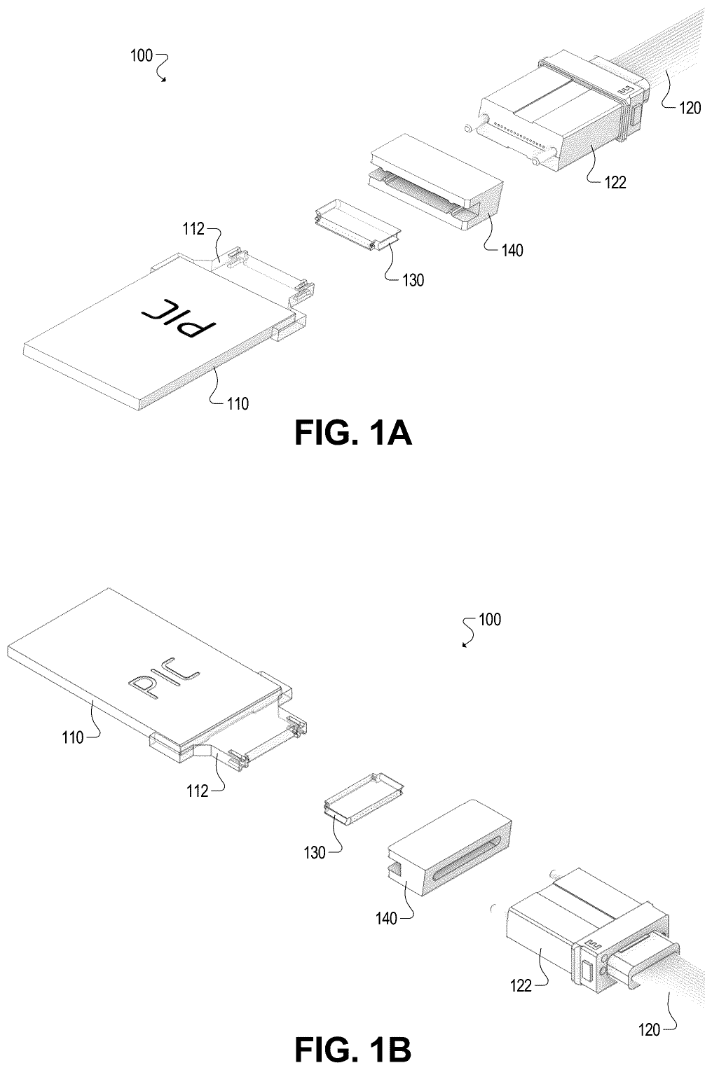

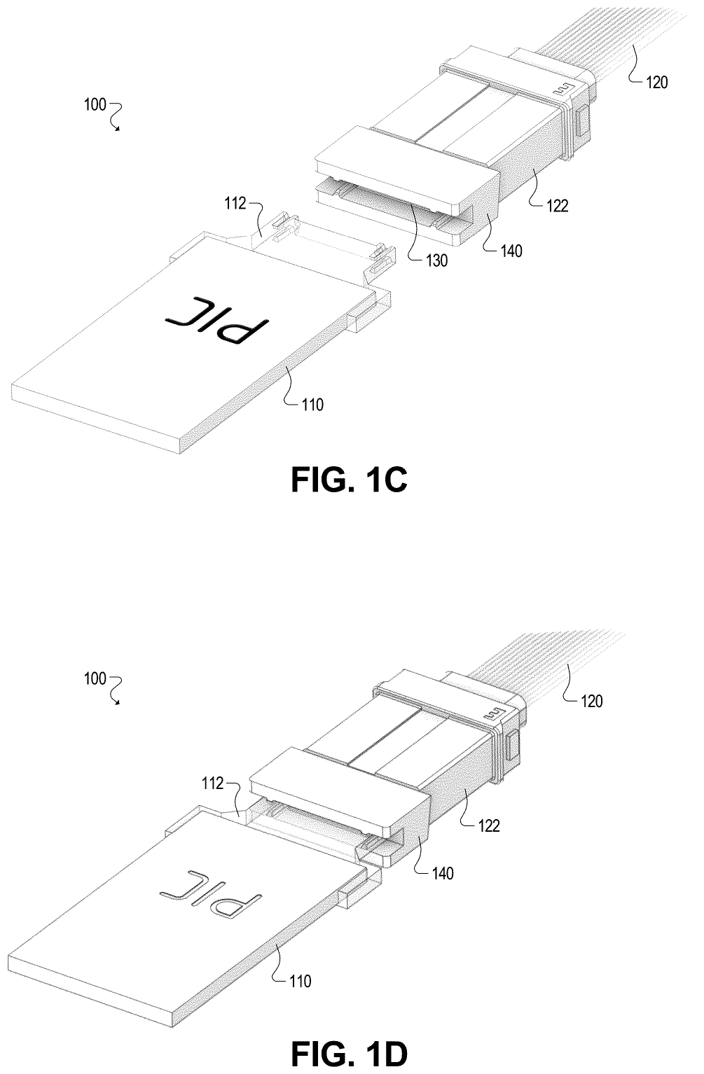

FIGS. 1A-D illustrate an example of an optical connection 100 between a photonic integrated circuit (PIC) and an incompatible fiber cable using an optical adapter. In particular, FIGS. 1A-B illustrate the optical connection 100 in unassembled form, FIG. 1C illustrates the optical connection 100 in partially assembled form, and FIG. 1D illustrates the optical connection 100 in fully assembled form.

In the illustrated embodiment, the PIC 110 is attached to a glass-based optical coupler 112, which is used to connect fiber cables that have corresponding glass-based ferrule connectors. In the illustrated example, however, the fiber cable 120 has a mechanical transfer (MT) ferrule connector 122, which is incompatible with the receptacle or socket on the glass coupler 112. As a result, an adapter 130 and corresponding adapter holder 140 are used to connect the MT ferrule connector 122 on the fiber cable 120 to the glass coupler 112 on the PIC 110, thus forming an optical connection 100 between the PIC 110 and the fiber cable 120. In this manner, the adapter 130 and adapter holder 140 collectively enable industry standard MT-based fiber cables 120 to be optically connected to the PIC 110 when they would otherwise be incompatible.

In some embodiments, for example, the adapter 130 may have multiple interfaces to mate with both the glass coupler 112 and the MT ferrule 122, along with waveguides extending between the respective interfaces. In this manner, when the respective interfaces of the adapter 130 are mated with the optical coupler 112 and the MT ferrule 122, the coupler 112 and ferrule 122 are optically coupled via the waveguides in the adapter 130. For example, one side of the adapter 130 may have an interface with the appropriate features for mating with the optical coupler 112 (e.g., alignment, mating, and/or retention features matching those on the particular optical coupler 112), and the other side may have an interface with the appropriate features for mating with the MT ferrule 122 (e.g., pin alignment features to receive/align the guide pins on the MT ferrule 122). Moreover, in some embodiments, the adapter 130 may be partially or entirely made of glass.

The adapter holder 140 may be used to hold the adapter 130 and/or assist in mating the adapter 130 to the glass coupler 112 and the MT ferrule 122. For example, in some embodiments, the adapter 130 may be relatively small, which may make it difficult for a person to physically hold, align, and connect the adapter 130 to the respective optical connectors 112, 122. As a result, the adapter holder 140 may provide a larger housing for the adapter 130 to make it easier for a person to hold and handle, along with features to assist in mating the adapter 130 to the respective connectors 112, 122.

In the illustrated embodiment, for example, the adapter holder 140 includes a cavity to hold or house the adapter 130, along with multiple interfaces with features to assist in mating the adapter 130 with the optical coupler 112 and the MT ferrule 122. For example, the respective interfaces of the adapter holder 140 include openings for the optical coupler 112 and the MT ferrule 122, along with additional alignment, mating, and/or retention features to make it easier to align, mate, and/or retain the adapter 130 to the optical coupler 112 and the MT ferrule 122. Moreover, in some embodiments, the adapter holder 140 may be partially or entirely made of plastic and/or glass.

In FIGS. 1A-B, the respective components are shown in unassembled form, including the PIC 110 with the attached optical coupler 112, the adapter 130, the adapter holder 140, and the fiber cable 120 with the MT ferrule 122. In FIG. 1C, the respective components are shown in partially assembled form, with the adapter 130 housed inside the adapter holder 140 and the adapter assembly 130, 140 connected to the MT ferrule 122 on the fiber cable 120. In FIG. 1D, the respective components are shown in fully assembled form, with the adapter assembly 130, 140 connected to both the MT ferrule 122 on the fiber cable 120 and the optical coupler 112 on the PIC 110.

The adapter 130 and adapter holder 140 can be designed for any pair of incompatible optical couplers and fiber ferrules by simply patterning the appropriate alignment, mating, and/or retention features on each interface of the adapter 130 and/or adapter holder 140. Further, in some embodiments, the adapter 130 and adapter holder 140 may be integrated and/or combined into a single component. For example, a single adapter may be patterned in a glass substrate with the collective features of both the adapter 130 and the adapter holder 140.

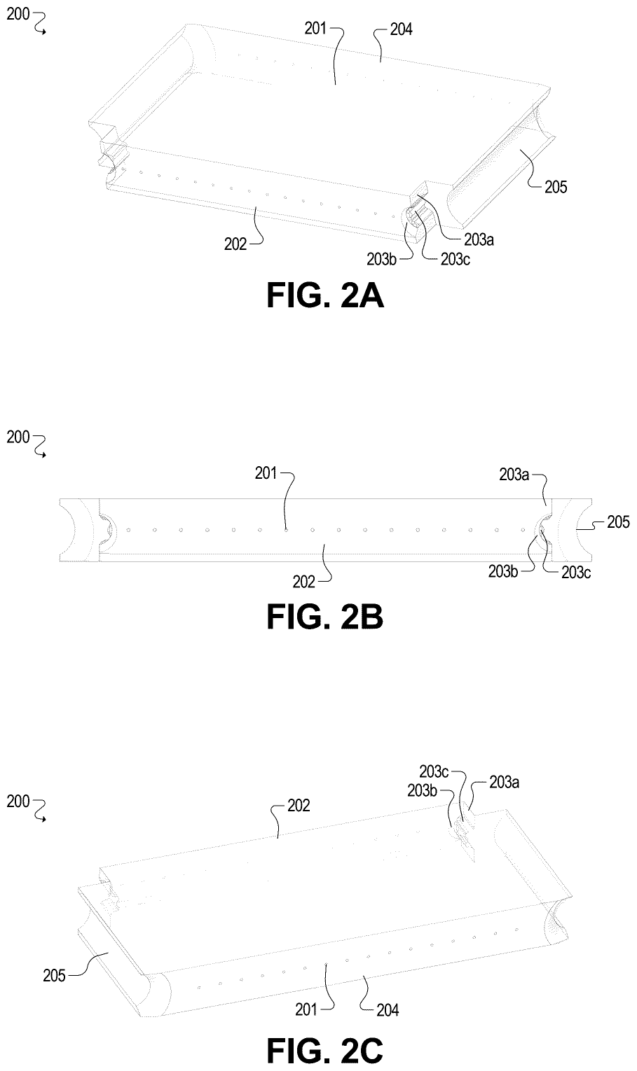

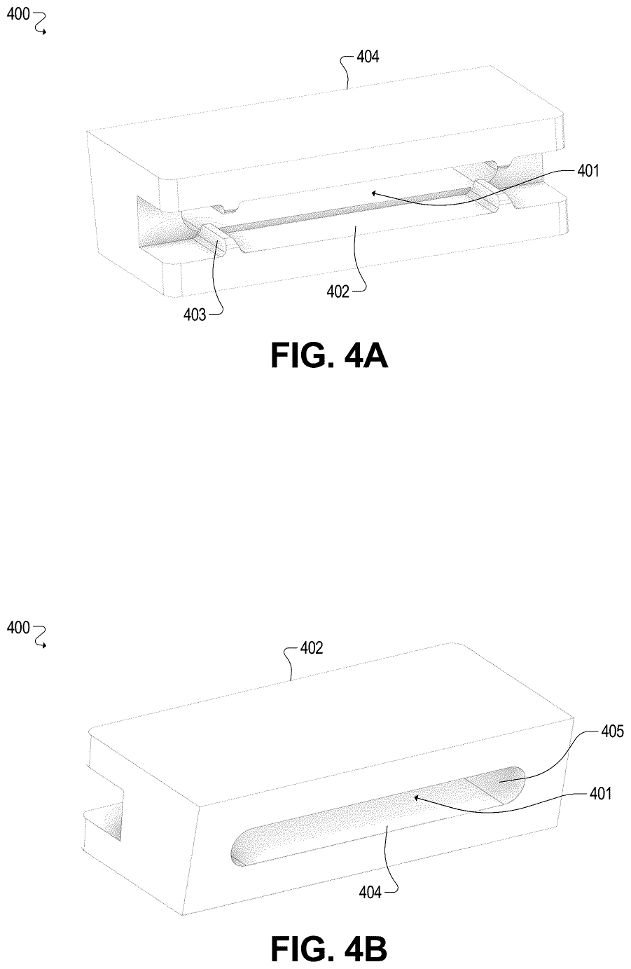

Example embodiments of the adapter 130 and adapter holder 140 are illustrated and described in further detail in connection with FIGS. 2-4. For example, in some embodiments, adapter 130 may be implemented using adapter 200 or 300 of FIGS. 2A-C or 3A-B, and adapter holder 140 may be implemented using adapter holder 400 of FIGS. 4A-B.

FIGS. 2A-C illustrate an example embodiment of an adapter 200 for connecting an incompatible fiber cable to a photonic integrated circuit (PIC). In particular, adapter 200 is designed to connect an MT-based ferrule on a fiber cable (e.g., MT ferrule 122 on fiber cable 120) to a glass-based optical coupler on a PIC (e.g., coupler 112 on PIC 110). In some embodiments, for example, adapter 200 may be used to implement adapter 130 in optical connection 100 of FIGS. 1A-D.

In the illustrated embodiment, adapter 200 includes two interfaces 202, 204 to respectively mate with an optical coupler on a PIC and an MT ferrule on a fiber cable (or to mate with any other optical connectors having the same types of interfaces), along with waveguides 201 extending between the respective interfaces 202, 204. In this manner, when the respective interfaces 202, 204 of adapter 200 are mated with the optical coupler and the MT ferrule, the coupler and ferrule are optically coupled via the waveguides 201 in adapter 200.

For example, one end of adapter 200 has an interface 202 with the appropriate mating/alignment features 203a-c for mating with an optical coupler, and the other end has an interface 204 with the appropriate mating/alignment features 205 for mating with an MT ferrule.

The mating/alignment features 205 on the interface 204 designed to mate with the MT ferrule include half-cylindrical grooves 205 to align the guide pins on an industry standard MT ferrule.

The mating/alignment features 203a-c on the interface 202 designed to mat with the optical coupler include a mating protrusion 203a, sidewall grooves 203b with chamfered edges, and semi-cylindrical protrusions 203c within the sidewall grooves 203b. The mating protrusion 203a is designed to mate with a corresponding mating receptacle/socket on the optical coupler. The sidewall grooves 203b are semi-cylindrical grooves with chamfered front edges, which are formed in the sidewalls of the mating protrusion 203a. Further, the sidewall grooves 203b include three semi-cylindrical protrusions 203c that extend along the inner surface of each groove. The sidewall grooves 203b and semi-cylinder protrusions 203c are designed to mate with corresponding sidewall protrusions (e.g., trapezoidal protrusions) in the mating receptacle on the optical coupler. The chamfered edges on the sidewall grooves 203b enable the adapter 200 to glide onto the corresponding sidewall protrusions in the mating receptacle on the optical coupler, thus aligning the waveguides 201 in the adapter 200 with those in the optical coupler. In some embodiments, the corresponding interface on the optical coupler may be similar to interface 602 of adapter 600.

In some embodiments, adapter 200 may be a glass-based component patterned with the respective waveguides 201 (e.g., holes), interfaces 202, 204, and mating/alignment features 203a-c, 205.

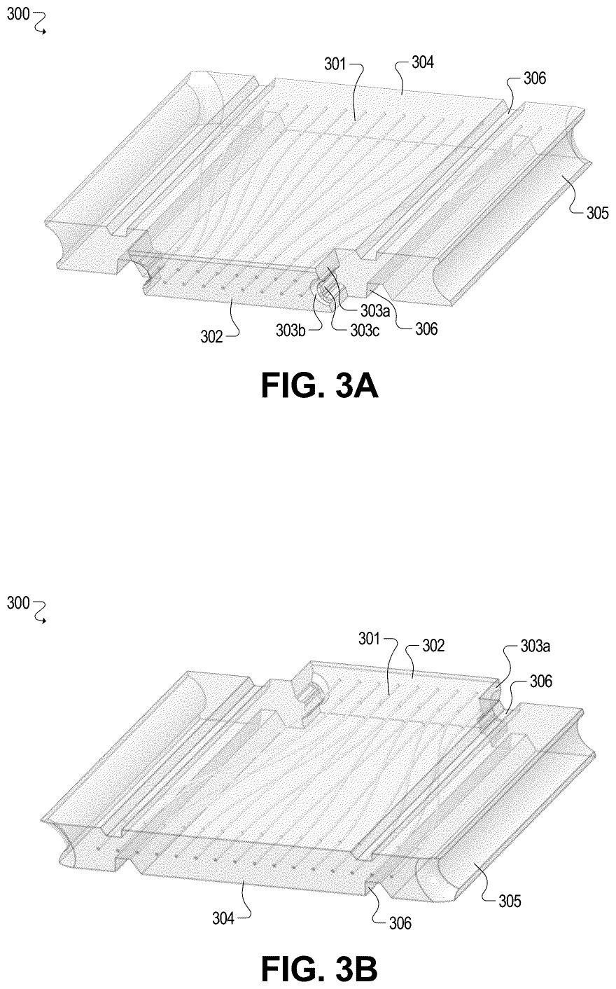

FIGS. 3A-B illustrate another example embodiment of an adapter 300 for connecting an incompatible fiber cable to a photonic integrated circuit (PIC). In particular, adapter 300 is designed to connect a MT-based ferrule on a fiber cable (e.g., MT ferrule 122 on fiber cable 120) to a glass-based optical coupler on a PIC (e.g., coupler 112 on PIC 110). In some embodiments, for example, adapter 300 may be used to implement adapter 130 in optical connection 100 of FIGS. 1A-D.

In the illustrated embodiment, adapter 300 includes waveguides 301, an optical coupler interface 302 with mating/alignment features 303a-c (e.g., mating protrusion 303a, sidewall grooves 303b with chamfered edges, cylindrical protrusions 303c), and an MT ferrule interface 304 with mating/alignment features 305 (e.g., half-cylindrical grooves 305 for the MT ferrule pins).

Adapter 300 is similar to adapter 200, except adapter 300 is designed for a different optical coupler (e.g., with a different interface) than adapter 200. For example, in adapter 200, the waveguides 201 are arranged in one row of sixteen (1×16) at both the coupler interface 202 and the ferrule interface 204, which mirrors the arrangement of waveguides on the optical coupler and the MT ferrule (not shown) that adapter 200 is designed to mate with. In adapter 300, however, the waveguides 301 are arranged in two rows of eight (2×8) at the coupler interface 302 and one row of sixteen (1×16) at the ferrule interface 304, which mirrors the respective arrangements of waveguides on the optical coupler and the MT ferrule (not shown) that adapter 300 is designed to mate with.

Further, adapter 300 includes grooves 306 (e.g., V-grooves, U-grooves) on the top and bottom outer surfaces, which may be used for alignment and/or retention purposes. In some embodiments, for example, the grooves 306 may interface with tracks (also referred to as “ribs” or “ridges”) on the adapter holder (e.g., tracks 403 on adapter holder 400) to assist in aligning the respective interfaces 302, 304 of the adapter 300 with the optical coupler and the MT ferrule. Alternatively, or additionally, the grooves 306 may interface with retention mechanisms, such as wires, that are used to hold the optical coupler and the MT ferrule against the respective interfaces 302, 304 of the adapter 300.

FIGS. 4A-B illustrate an example embodiment of an adapter holder 400 for an adapter used to connect an incompatible fiber cable to a photonic integrated circuit (PIC). In particular, adapter holder 400 is designed to hold an adapter (e.g., adapter 130, 200, 300) for connecting an MT-based ferrule on a fiber cable (e.g., MT ferrule 122 on fiber cable 120) to a glass-based optical coupler on a PIC (e.g., coupler 112 on PIC 110). In some embodiments, for example, adapter holder 400 may be used to implement adapter holder 140 in optical connection 100 of FIGS. 1A-D.

The adapter holder 400 may provide a housing to hold the adapter and optionally features to assist in mating the adapter to an optical coupler on a PIC and an MT ferrule on a fiber cable (or to assist in mating with any other optical connectors having the same types of interfaces). In the illustrated embodiment, for example, adapter holder 400 includes a cavity 401 to house the adapter, along with two interfaces or openings 402, 404 to allow the adapter to mate with the optical coupler and the MT ferrule.

For example, one end of adapter holder 400 has an interface 402 with an opening for the optical coupler, along with mating/alignment features 403 to assist in mating the adapter to the optical coupler. The other end of adapter holder 400 has an interface 404 with an opening for the MT ferrule, along with mating/alignment features 405 to assist in mating the adapter to the MT ferrule.

The mating/alignment features 403 on the coupler interface 402 include tracks 403 to interface with corresponding grooves on the optical coupler and optionally the adapter itself (e.g., grooves 306 on adapter 300). The mating/alignment features 405 on the ferrule interface 404 include half-cylindrical sidewall grooves 405 to align the guide pins on an industry standard MT ferrule.

These alignment features 403, 405 collectively serve to pre-align the optical coupler and the MT ferrule to the adapter, at which point the coupler and ferrule engage the mating/alignment features on the adapter itself for final alignment.

In some embodiments, adapter holder 400 may also include retention features (not shown) to assist in retaining the optical coupler and the MT ferrule to the adapter. For example, the outer surface of the adapter holder 400 may include grooves for retention wires that are used to hold the coupler and the ferrule against the respective interfaces of the adapter.

In some embodiments, adapter holder 400 may be a plastic and/or glass-based component molded or patterned with the cavity 401, interfaces 402, 404, and mating/alignment features 403, 405.

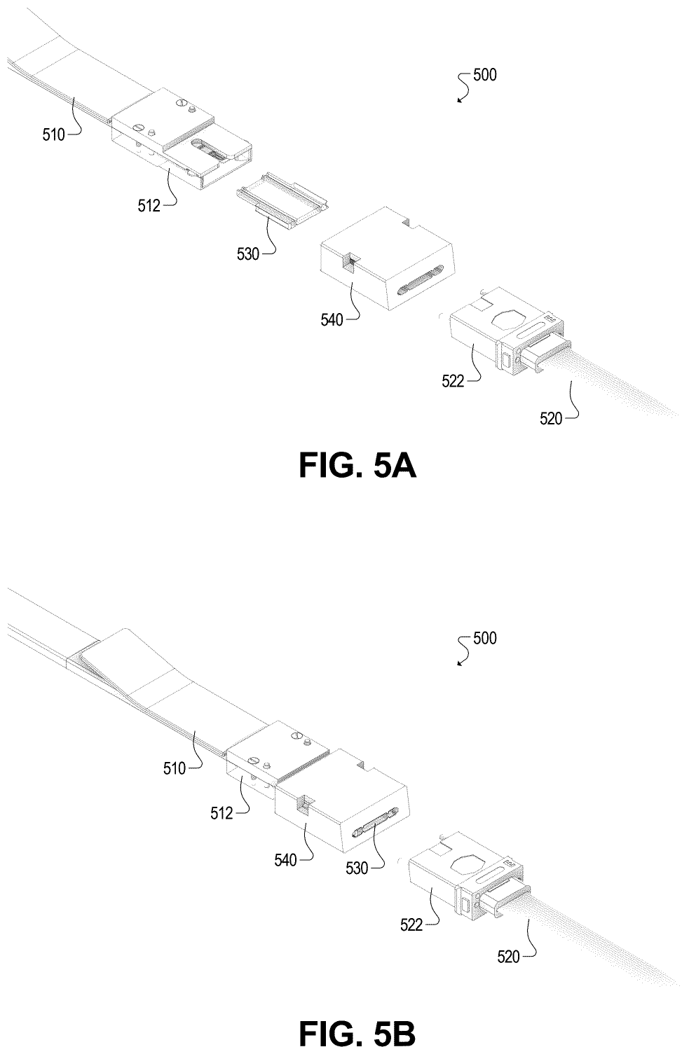

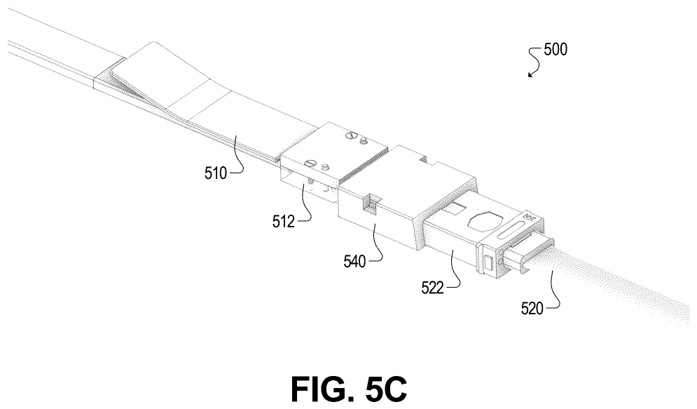

FIGS. 5A-C illustrate an example of an optical connection 500 between heterogenous fiber cables 510, 520 using an optical adapter assembly 530, 540. In particular, FIG. 5A illustrates the optical connection 500 in unassembled form, FIG. 5B illustrates the optical connection 500 in partially assembled form, and FIG. 5C illustrates the optical connection 500 in fully assembled form.

In the illustrated embodiment, a fiber cable 510 with a glass ferrule 512 is connected to a fiber cable 520 with an MT ferrule 522 using an optical adapter 530 and a corresponding adapter holder 540. For example, fiber cable 510 includes a glass-based ferrule connector 512, which is designed to mate with an optical coupler on a photonic integrated circuit (PIC) (e.g., coupler 112 on PIC 110), while fiber cable 520 includes an industry standard MT ferrule connector 522, which is incompatible with the glass ferrule connector 512 on fiber cable 510. As a result, the adapter 530 and adapter holder 540, which may be collectively referred to as an adapter assembly, are used to connect the glass ferrule connector 512 on fiber cable 510 to the MT ferrule connector 522 on fiber cable 520, thus forming an optical connection 500 between the heterogenous fiber cables 510, 520. In this manner, the adapter assembly 530, 540 enables glass-ferrule-based fiber cables 510 to be optically connected to industry standard MT-based fiber cables 520 when they would otherwise be incompatible.

In some embodiments, for example, the adapter 530 may have multiple interfaces to mate with both the glass ferrule 512 and the MT ferrule 522, along with waveguides extending between the respective interfaces. In this manner, when the respective interfaces of the adapter 530 are mated with the glass ferrule 512 and the MT ferrule 522, the fiber cables 510, 520 are optically coupled via the waveguides in the adapter 530. For example, one side of the adapter 530 may have an interface with the appropriate features for mating with the glass ferrule 512 (e.g., alignment, mating, and/or retention features corresponding to those on the particular glass ferrule 512), and the other side may have an interface with the appropriate features for mating with the MT ferrule 522 (e.g., pin alignment features to receive/align the guide pins on the MT ferrule 522). Moreover, in some embodiments, the adapter 530 may be partially or entirely made of glass.

The adapter holder 540 may be used to hold the adapter 530 and/or assist in mating the adapter 530 to the glass ferrule 512 and the MT ferrule 522. For example, in some embodiments, the adapter 530 may be relatively small, which may make it difficult for a person to physically hold, align, and connect the adapter 530 to the respective optical connectors 512, 522. As a result, the adapter holder 540 may provide a larger housing for the adapter 530 to make it easier for a person to hold and handle, along with features to assist in mating the adapter 530 to the respective connectors 512, 522.

In the illustrated embodiment, for example, the adapter holder 540 includes a cavity to hold or house the adapter 530, along with multiple interfaces with features to assist in mating the adapter 530 with the glass ferrule 512 and the MT ferrule 522. For example, the respective interfaces of the adapter holder 540 include openings for the glass ferrule 512 and the MT ferrule 522, along with additional alignment, mating, and/or retention features to make it easier to align, mate, and/or retain the adapter 530 to the glass ferrule 512 and the MT ferrule 522. In some embodiments, for example, the adapter holder 540 may include the industry standard retention features for engaging an MT ferrule 522. Moreover, in some embodiments, the adapter holder 540 may be partially or entirely made of plastic and/or glass.

In FIG. 5A, the respective components are shown in unassembled form, including the fiber cable 510 with the glass ferrule 512, the adapter 530, the adapter holder 540, and the fiber cable 520 with the MT ferrule 522. In FIG. 5B, the respective components are shown in partially assembled form, with the adapter 530 housed inside the adapter holder 540 and the adapter assembly 530, 540 connected to the glass ferrule 512 on fiber cable 510. In FIG. 5C, the respective components are shown in fully assembled form, with the adapter assembly 530, 540 connected to both the glass ferrule 512 on fiber cable 510 and the MT ferrule 522 on fiber cable 520.

The adapter 530 and adapter holder 540 can be designed for any pair of incompatible fiber cables or ferrules by simply patterning the appropriate alignment, mating, and/or retention features on each interface of the adapter 530 and/or adapter holder 540. Further, in some embodiments, the adapter 530 and adapter holder 540 may be integrated and/or combined into a single component. For example, a single adapter may be patterned in a glass substrate with the collective features of both the adapter 530 and the adapter holder 540.

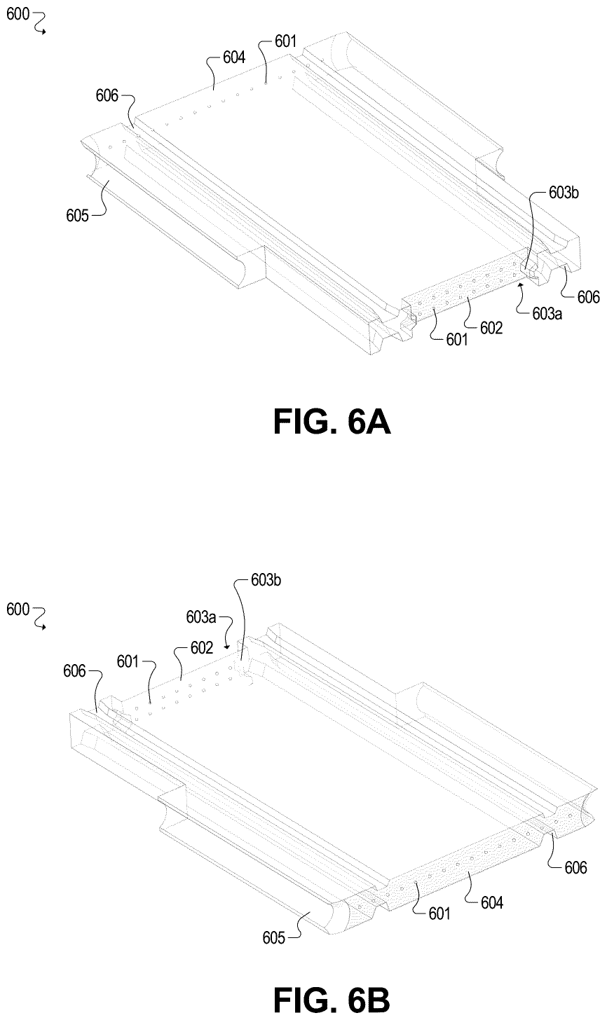

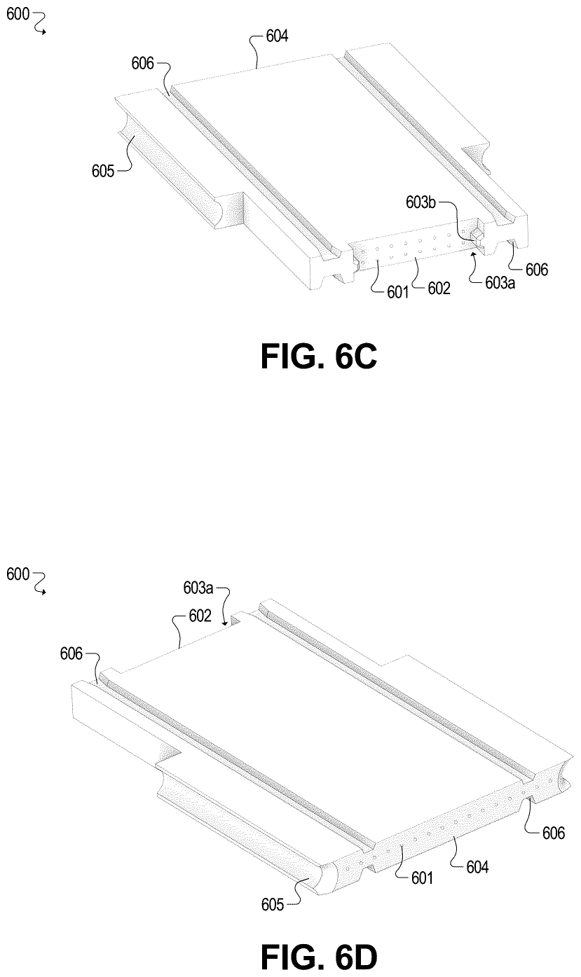

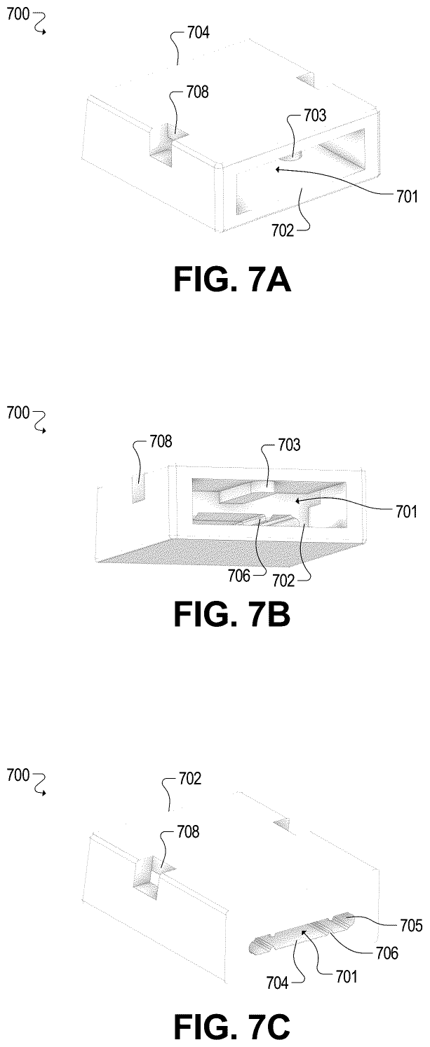

Example embodiments of the adapter 530 and adapter holder 540 are illustrated and described in further detail in connection with FIGS. 6-7. For example, in some embodiments, adapter 530 may be implemented using adapter 600 of FIGS. 6A-D, and adapter holder 540 may be implemented using adapter holder 700 of FIGS. 7A-C.

FIGS. 6A-D illustrate an example embodiment of an adapter 600 for connecting heterogenous fiber cables. In particular, adapter 600 is designed to connect a fiber cable with a glass ferrule (e.g., fiber cable 510 with glass ferrule 512) to a fiber cable with an MT ferrule (e.g., fiber cable 520 with MT ferrule 522), which would otherwise be incompatible. In some embodiments, for example, adapter 600 may be used to implement adapter 530 in optical connection 500 of FIGS. 5A-C.

In the illustrated embodiment, adapter 600 includes two interfaces 602, 604 to respectively mate with a glass ferrule and an MT ferrule on fiber cables (or any other optical connectors having the same types of interfaces), along with waveguides 601 extending between the respective interfaces 602, 604. The waveguides 601 are arranged in two rows of eight (2×8) at the interface 602 that mates with the glass ferrule, which mirrors the arrangement of the fiber array in the glass ferrule. Further, the waveguides 601 are arranged in one row of sixteen (1×16) at the interface 604 that mates with the MT ferrule, which mirrors the arrangement of the fiber array in the MT ferrule. In this manner, when the respective interfaces 602, 604 of adapter 600 are mated with the glass ferrule and the MT ferrule, the waveguides 601 in adapter 600 are aligned with the fiber arrays in the respective ferrules, thus optically coupling the fiber cables.

For example, one end of adapter 600 has an interface 602 with the appropriate mating/alignment features 603a-b for mating with a glass ferrule, and the other end has an interface 604 with the appropriate mating/alignment features 605 for mating with an MT ferrule.

The mating/alignment features 605 on the interface 604 designed to mate with the MT ferrule include half-cylindrical grooves 605 to align the guide pins on an industry standard MT ferrule.

The mating/alignment features 603a-b on the interface 602 designed to mate with the glass ferrule include a mating recess 603a and sidewall protrusions 603b. The mating recess 603a is designed to mate with a corresponding mating protrusion on the glass ferrule. The sidewall protrusions 603b are semi-cylindrical protrusions with chamfered surfaces and edges (e.g., rectangular surfaces and trapezoidal front edges), which are formed on the sidewalls of the mating recess 603a. The sidewall protrusions 603b are designed to mate with corresponding sidewall grooves (e.g., semi-cylindrical grooves) in the mating protrusion on the glass ferrule. The chamfered edges/surfaces on the sidewall protrusions 603b enable the adapter 600 to glide into the corresponding sidewall grooves in the mating protrusion on the glass ferrule, thus aligning the waveguides 601 in the adapter 600 with the fibers in the glass ferrule. In some embodiments, the corresponding interface on the glass ferrule may be similar to interfaces 202, 302 of adapters 200, 300.

Further, adapter 600 includes grooves 606 (e.g., V-grooves, U-grooves) on the top and bottom surfaces, which may be used for alignment and/or retention purposes. In some embodiments, for example, the grooves 606 may interface with alignment tracks on the adapter holder (e.g., alignment tracks 706 on adapter holder 700) to assist in aligning the adapter 600 within the adapter holder and aligning the interfaces 602, 604 of the adapter 600 with the glass and MT ferrules. Alternatively, or additionally, the grooves 606 may interface with retention mechanisms, such as wires, that are used to hold the glass ferrule and/or MT ferrule against the respective interfaces 602, 604 of the adapter 600.

In some embodiments, adapter 600 may be a glass-based component patterned with the respective waveguides 601 (e.g., holes extending through the glass), interfaces 602, 604, and mating/alignment features 603a-b, 605.

FIGS. 7A-C illustrate an example embodiment of an adapter holder 700 for an adapter used to connect heterogenous fiber cables. In particular, adapter holder 700 is designed to hold an adapter (e.g., adapter 530, 600) for connecting a fiber cable with a glass ferrule (e.g., fiber cable 510 with glass ferrule 512) to a fiber cable with an MT ferrule (e.g., fiber cable 520 with MT ferrule 522). In some embodiments, for example, adapter holder 700 may be used to implement adapter holder 540 in optical connection 500 of FIGS. 5A-C.

The adapter holder 700 may provide a housing to hold the adapter and optionally features to assist in mating the adapter to the glass ferrule and the MT ferrule on the respective fiber cables (or any other optical connectors having the same types of interfaces). In the illustrated embodiment, for example, adapter holder 700 includes a cavity 701 to house the adapter, along with two interfaces or openings 702, 704 to allow the adapter to mate with the glass ferrule and the MT ferrule.

The cavity 701 of the adapter holder 700 includes alignment tracks 706 for the adapter, which interface with corresponding grooves on the adapter (e.g., grooves 606 on adapter 600) to align the adapter within the cavity 701 of the adapter holder 700.

Further, one end of adapter holder 700 has an interface 702 with an opening for the glass ferrule, along with mating/alignment features 703 to assist in mating the adapter to the glass ferrule. The other end of adapter holder 700 has an interface 704 with an opening for the MT ferrule, along with mating/alignment features 705 to assist in mating the adapter to the MT ferrule.

The mating/alignment features 703 on the glass ferrule interface 702 include an alignment track 703 to interface with a corresponding slot on the glass ferrule (e.g., the slot shown on the top of glass ferrule 512). The mating/alignment features 705 on the ferrule interface 704 include half-cylindrical sidewall grooves 705 to align the guide pins on an industry standard MT ferrule (e.g., the pins on MT ferrule 522).

These alignment features 703, 705 collectively serve to pre-align the glass ferrule and the MT ferrule to the adapter, at which point the respective ferrules engage the mating/alignment features on the adapter itself for final alignment.

In some embodiments, adapter holder 700 may also include retention features to assist in retaining the glass ferrule and/or the MT ferrule to the adapter. In the illustrated embodiment, for example, adapter holder 700 includes a retention notch 708, which is designed to mate with a retention latch on the glass ferrule connector that mates with interface 702. Additionally, or alternatively, adapter holder 700 may include other retention features (not shown), such as grooves on the outer surface for retention wires, which may be used to hold one or both of the ferrules against the respective interfaces of the adapter.

In some embodiments, adapter holder 700 may be a plastic and/or glass-based component molded or patterned with the cavity 701, interfaces 702, 704, and mating/alignment features 703, 705, 706.

It should be appreciated that adapter and adapter holder embodiments described in connection with FIGS. 1-7 are merely presented as examples. In other embodiments, certain components or features may be omitted, added, rearranged, modified, or combined. For example, the respective interfaces of the adapter and adapter holder may be modified for any types of optical connectors or interfaces, whether on photonics circuitry, fiber cables, or other optical components. Further, the alignment, mating, and retention features from the various embodiments may be modified or combined, such as by using features with different shapes (e.g., protrusions/grooves/cavities with varying shapes) or different types of features altogether.

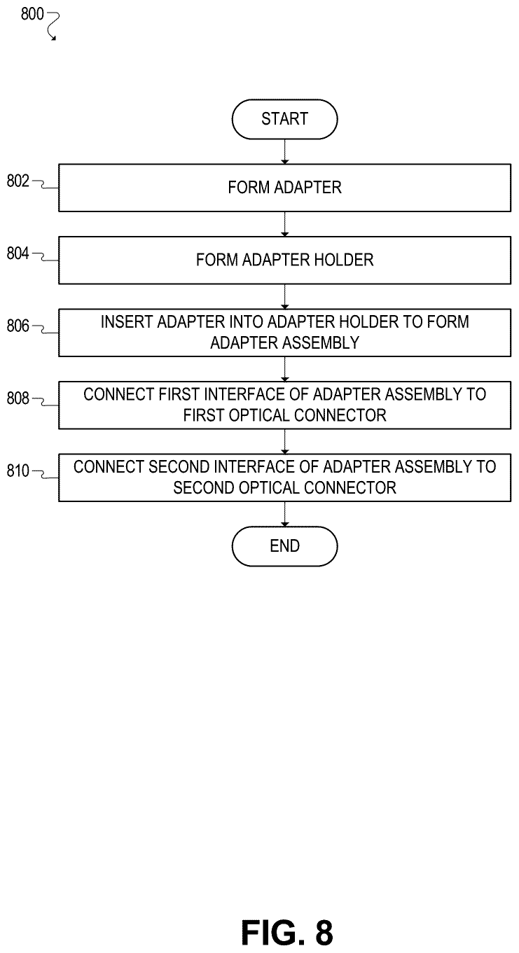

FIG. 8 illustrates a process flow 800 for forming and using an optical adapter assembly. In some embodiments, for example, the illustrated process flow may be used to form and/or use the optical adapter embodiments described throughout this disclosure (e.g., optical adapters/holders 130, 140, 530, 540, 915). However, it will be appreciated in light of the present disclosure that the illustrated process flow is only one example methodology for arriving at the example optical adapters shown and described throughout this disclosure.

The process flow begins at block 802 by forming an optical adapter. The optical adapter may be used to optically couple multiple heterogenous optical connectors that are not designed to mate with each other (e.g., optical sockets and/or optical plugs with heterogenous interfaces).

The adapter may include a first interface to mate with a first optical connector, a second interface to mate with a second optical connector, and one or more waveguides extending between the first interface and the second interface. In some embodiments, for example, the first interface may be at one end of the adapter, the second interface may be at another end of the adapter, and the waveguides may extend through the optical adapter from the first interface to the second interface. In this manner, when the first interface is mated with the first optical connector and the second interface is mated with the second optical connector, the first and second optical connectors are optically coupled via the waveguides in the adapter.

Further, in some embodiments, the adapter may include mating and/or alignment features to mate and/or align the adapter with the first and second optical connectors. For example, the first interface may include a first set of alignment features to align the adapter with the first optical connector (e.g., by aligning the waveguides at the first interface of the adapter with waveguides in the first optical connector), and the second interface may include a second set of alignment features to align the adapter with the second optical connector (e.g., by aligning the waveguides at the second interface of the adapter with waveguides in the second optical connector). Similarly, the first and second interfaces may include sets of mating and/or retention features to mate with and/or retain the first and second optical connectors.

In some embodiments, the adapter may be partially or entirely made of glass and/or polymers. For example, the adapter may be a glass interposer formed by patterning the interfaces, mating/alignment features, and/or waveguides in a glass substrate (e.g., using laser-based etching techniques).

The process flow then proceeds to block 804 to form an adapter holder for the optical adapter. The adapter holder may be used to hold the adapter and/or assist in aligning, mating, and/or retaining the adapter with the first and second optical connectors. For example, in some embodiments, the adapter may be relatively small, which may make it difficult for a person to physically handle, align, and/or connect the adapter to the respective optical connectors. As a result, the adapter holder may provide a larger housing for the adapter that is easier for a person to handle. The adapter holder may also include additional alignment, mating, and/or retention features to make it easier to align, mate, and/or retain the adapter with the respective optical connectors.

In some embodiments, for example, the adapter holder may include a cavity to hold the adapter, along with first and second interfaces to help align, mate, and/or retain the first and second interfaces of the adapter to the first and second optical connectors. For example, the first interface of the adapter holder may include a first set of alignment features to align the first optical connector to the first interface of the adapter, and the second interface of the adapter holder may include a second set of alignment features to align the second optical connector to the second interface of the adapter. Similarly, the first and second interfaces of the adapter holder may include sets of mating and/or retention features to mate and/or retain the first and second interfaces of the adapter to the first and second optical connectors.

In some embodiments, the adapter holder may be partially or entirely made of plastic and/or glass.

Further, in some embodiments, the adapter and adapter holder may be integrated and/or combined into a single component. For example, a single component with the collective features of both the adapter and the adapter holder may be patterned in a glass substrate.

The process flow then proceeds to block 806 to insert the adapter into the adapter holder to form a completed adapter assembly. In some embodiments, the adapter may be inserted into the cavity of the adapter holder and attached using a suitable attachment mechanism, such as adhesives, mating or retention features (e.g., retaining pin, set screw), or friction.

The process flow then proceeds to block 808 to connect the first interface of the adapter assembly to a first optical connector, and then to block 810 to connect the second interface of the adapter assembly to a second optical connector. In some embodiments, for example, the respective optical connectors may be a plug or a socket on an optical cable (e.g., a ferrule coupled to a bundle of optical fibers) or an optical interface (e.g., an integrated circuit with an interface for optical communication).

As an example, the first optical connector may be an optical socket on an optical interface and the second optical connector may be an optical plug on an optical cable (or vice versa). For example, the optical interface may be part of an integrated circuit package that includes an optical coupler with an optical socket, a photonic integrated circuit (PIC) to send or receive optical signals via the optical socket, an electronic integrated circuit (EIC) to control the PIC, and/or other computing component(s) that utilize the optical interface for optical communication (e.g., an XPU). Moreover, the optical cable may include an optical plug attached to a bundle of optical fibers. For example, the optical plug may be a mechanical transfer (MT) ferrule, glass ferrule, or other type of optical ferrule attached to glass fibers. Moreover, the respective interfaces of the adapter assembly may be connected to the optical cable and the optical socket. For example, the plug on the optical cable may be plugged into one interface of the adapter assembly, and the other interface of the adapted assembly may be plugged into the socket on the optical interface.

As another example, the first optical connector may be a first optical plug on a first optical cable and the second optical connector may be a second optical plug on a second optical cable. In some embodiments, the first optical plug may be a glass ferrule on a fiber cable and the second optical plug may be a mechanical transfer (MT) ferrule on a fiber cable (or vice versa). Moreover, the respective interfaces of the adapter assembly may be connected to the respective optical cables. For example, the plug on the first optical cable may be plugged into one interface of the adapter assembly and the plug on the second optical cable may be plugged into the other interface of the adapter assembly.

At this point, the process flow may be complete. In some embodiments, however, the process flow may restart and/or certain blocks may be repeated. For example, in some embodiments, the process flow may restart at block 802 to continue forming and/or using optical adapters.

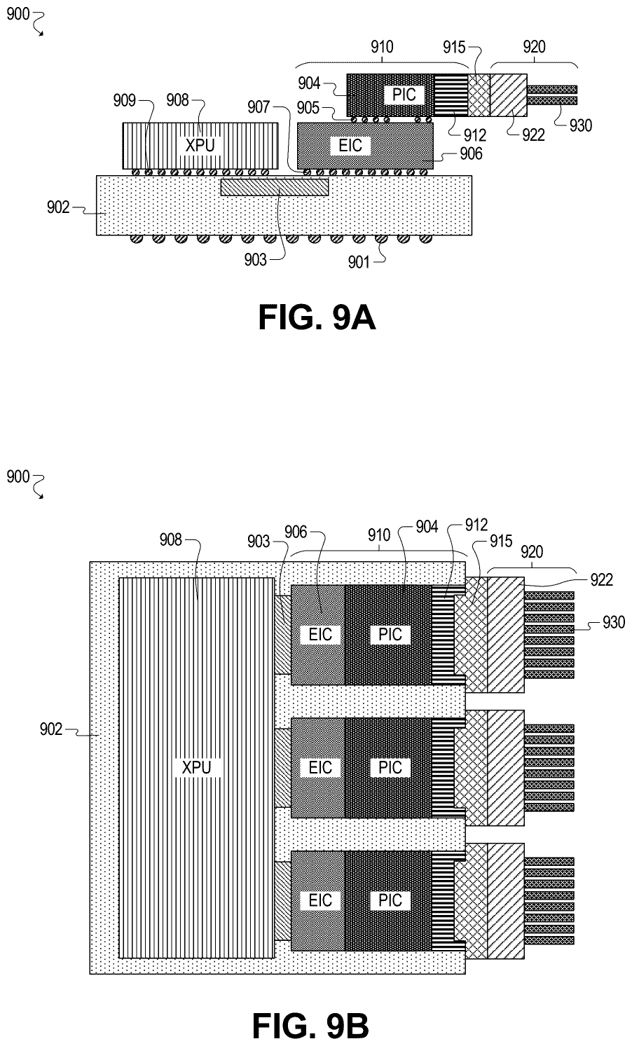

FIGS. 9A-B illustrate an example embodiment of an optical package 900 in accordance with certain embodiments. In particular, cross-section and plan views of optical package 900 are respectively shown in FIGS. 9A and 9B. In the illustrated embodiment, the optical couplers 912 and optical ferrules 922 are implemented using heterogenous interfaces/connectors that are not designed to mate. As a result, optical adapters 915 are used to indirectly mate the optical couplers 912 with the optical ferrules 922, as described further below.

In the illustrated embodiment, the optical package 900 includes an XPU 908 and multiple optical interfaces 910 on a package substrate 902, along with optical cables 920 plugged into the respective optical interfaces 910.

Each optical interface 910 includes an optical coupler 912, a photonic integrated circuit (PIC) 904, and an electronic integrated circuit (EIC) 906. The EICs 906 are attached to the top surface of the package substrate 902, the PICs 904 are attached to the top surface of corresponding EICs 906, and the optical couplers 912 are attached to the side/edge of corresponding PICs 904.

The EICs 906 are used to control the PICs 904 and may include components such as drivers, transimpedance amplifiers (TIA), carrier phase recovery (CPR), clock/data recovery (CDR), serializer/deserializer, equalizer, sampler, and so forth. The EICs 906 are electrically coupled to the package substrate 902 via conductive contacts 907 (e.g., bumps/micro-bumps), and the EICs 906 are further electrically coupled to the XPU 908 via the bridges 903 embedded in the substrate 902.

The PICs 904 are used to send and/or receive optical signals via fiber arrays 930 (e.g., on behalf of the XPU 908). Each PIC 904 includes components and circuitry for sending and receiving optical signals, such as laser diodes (LD)/modulators (LD-MOD) (e.g., for transmitting optical signals), photodiodes (PD) (e.g., for receiving optical signals), waveguides, optical couplers, collimation/refocusing lenses, reflection mirrors, and so forth. Each PIC 904 is controlled by an associated EIC 906 and is electrically coupled to the top surface of the EIC 906 via conductive contacts 905 (e.g., bumps/micro-bumps).

An optical coupler 912 is also attached to each PIC 904. The optical coupler 912, which may also be referred to as an optical interposer, is used to optically couple, or route optical signals (e.g., light) between, the PIC 904 and another optical component, such as an optical cable 920. In some embodiments, the optical coupler 912 may include an interface attached to the PIC 904, an interface to mate with an optical ferrule 922 on an optical cable 920, and waveguides to route optical signals between the respective interfaces. The optical coupler 912 may optionally include various other optical and/or electrical routing features, such as through-glass vias, reflection mirrors, and so forth.

Each optical cable 920 includes an optical ferrule 922 attached to a bundle of optical (e.g., glass) fibers 930, which may be referred to as a fiber array or fiber array unit (FAU). The optical ferrule 922 may be used to optically couple, or route optical signals between, the fiber array 930 and an optical coupler 912. In some embodiments, the optical ferrule 922 may include an interface attached to the fiber array 930 (e.g., holes in the ferrule 922 in which the fibers 930 are inserted), an interface to mate with an optical coupler 912, and waveguides to route optical signals between the respective interfaces.

In some embodiments, for example, the optical coupler 912 and the optical ferrule 922 may include complementary pluggable interfaces that are designed to mate. For example, the optical coupler 912 may include an optical socket and the optical ferrule 922 may include a corresponding optical plug designed to mate with the optical socket (or vice versa). In this manner, each PIC 904 is optically coupled to an associated fiber array 930 via the mated optical coupler 912 and optical ferrule 922.

Further, in some embodiments, the optical coupler 912 and optical ferrule 922 may include complementary mating and alignment features (e.g., mating protrusions and receptacles, pins and pin holes, grooves) to ensure they mate with each other with the requisite degree of alignment, as the waveguides in the ferrule 922 must be precisely aligned with the waveguides in the optical coupler 912. For example, when the optical ferrule 922 is plugged into to the optical coupler 912, their respective mating and alignment features engage, which causes the waveguides in the ferrule 922 to precisely align with the waveguides in the optical coupler 912. In this manner, the PIC 904 is optically coupled to the fiber array 930 via the mated optical coupler 912 and ferrule 922, which enables the PIC 904 to send and receive optical signals via the fiber array 930.

In some embodiments, the optical coupler 912 and/or optical ferrule 922 may be made of glass, and their respective features (e.g., interfaces, mating/alignment features, waveguides) may be patterned in the glass (e.g., using laser etching techniques).

In the illustrated embodiment, however, the optical couplers 912 and the optical ferrules 922 are implemented using heterogenous interfaces that are not designed to mate. As a result, optical adapters 915 are used to indirectly mate the optical couplers 912 with the optical ferrules 922, thus optically coupling the PICs 904 to the fiber arrays 930. In various embodiments, the adapters 915 may be implemented using any or all aspects of the optical adapters described throughout this disclosure (e.g., adapters 130, 530, adapter holders 140, 540).

The fiber array 930 may be used to send and receive optical signals to and from other components (not shown). For example, the other end of the fiber array 930 may be optically coupled to other components (not shown), such as other computing components that are part of the same device or system as optical package 900 (e.g., processors, XPUs, network interface controllers (NICs), storage, memory, I/O devices, other integrated circuits), an external device or system, a switch, another optical connector (e.g., a connector similar to optical coupler 912 and/or optical ferrule 922, a standard optical connector such as a mechanical transfer (MT) or multi-fiber push on (MPO) connector), a fiber cable, and so forth.

The XPU 908 is attached to the top surface of the package substrate 902. Moreover, the XPU 908 is electrically coupled to the package substrate 902 via conductive contacts 909 (e.g., bumps/micro-bumps), which serve as the first level interconnect (FLI) for the XPU 908. The XPU 908 is also electrically coupled to the EICs 906 via bridges 903 embedded in the substrate 902 (e.g., embedded multi-die interconnect bridges (EMIB)). In this manner, the XPU 908 can use the EICs 906 to communicate over the respective optical interfaces 910.

The XPU 908 may include any type or combination of integrated circuitry that uses the optical interfaces 910 for optical communication. For example, the XPU 908 may include any type or combination of processing units or other computing components, including, but not limited to, microcontrollers, microprocessors, processor cores, central processing units (CPUs), graphics processing units (GPUs), vision processing units (VPUs), tensor processing units (TPUs), application-specific integrated circuits (ASICs), field-programmable gate arrays (FPGAs), input/output (I/O) controllers and devices, switches, network interface controllers (NICs), persistent storage devices, and memory.

The package substrate 902 includes conductive contacts 901 (e.g., balls, pads) on the bottom surface, which serve as the second level interconnect (SLI) to a next-level component, such as a printed circuit board (e.g., a motherboard) and/or another integrated circuit package (not shown). The package substrate 902 also includes conductive traces (not shown) patterned in the substrate to provide power and input/output (I/O) to the respective components in package 900 (e.g., XPU 908, EICs 906, PICs 904).

In some embodiments, the optical package 900 may be part of an electronic device or system, such as a mobile device, a wearable device, a computer, a server, a video playback device, a video game console, a display device, a camera, or an appliance. For example, the optical package 900 and various other electronic components may be electrically coupled to a circuit board within the electronic device.

It should be appreciated that optical package 900 is merely presented as an example. In other embodiments, certain components may be omitted, added, rearranged, modified, or combined. For example, embodiments may include any number, combination, or arrangement of PICs and EICs (e.g., for higher bandwidth and/or redundancy), optical connectors, optical couplers, optical ferrules, optical interposers, fibers, bridges, XPUs or other computing components, substrates, surface cavities in the substrate, conductive contacts, conductive traces, vias, integrated circuit packages, and so forth.

### Example Integrated Circuit Embodiments

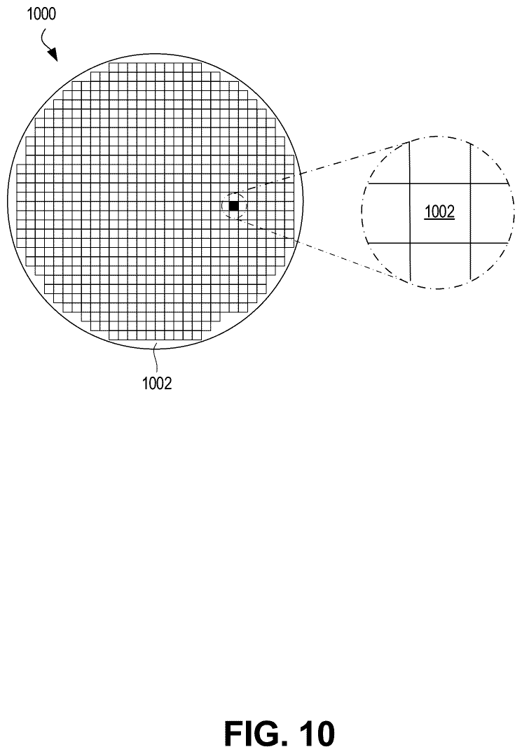

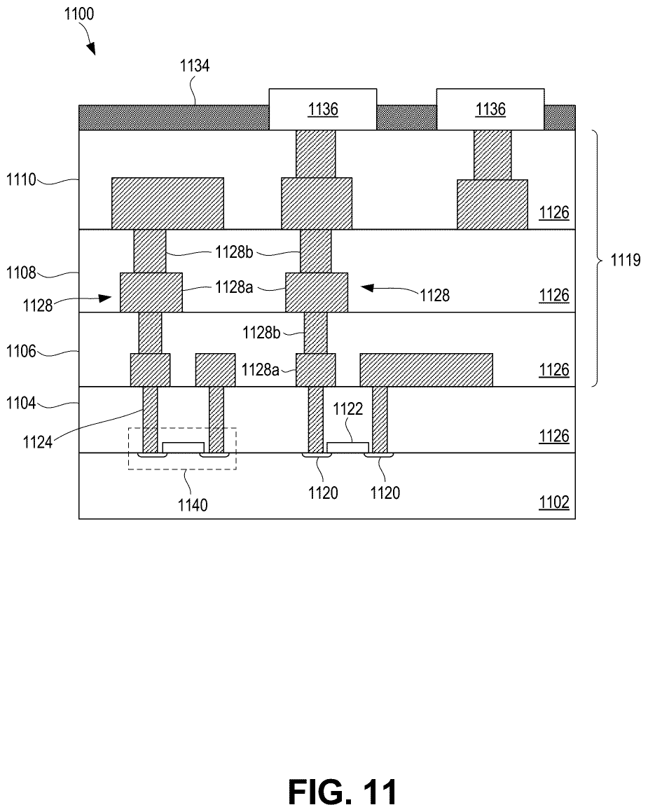

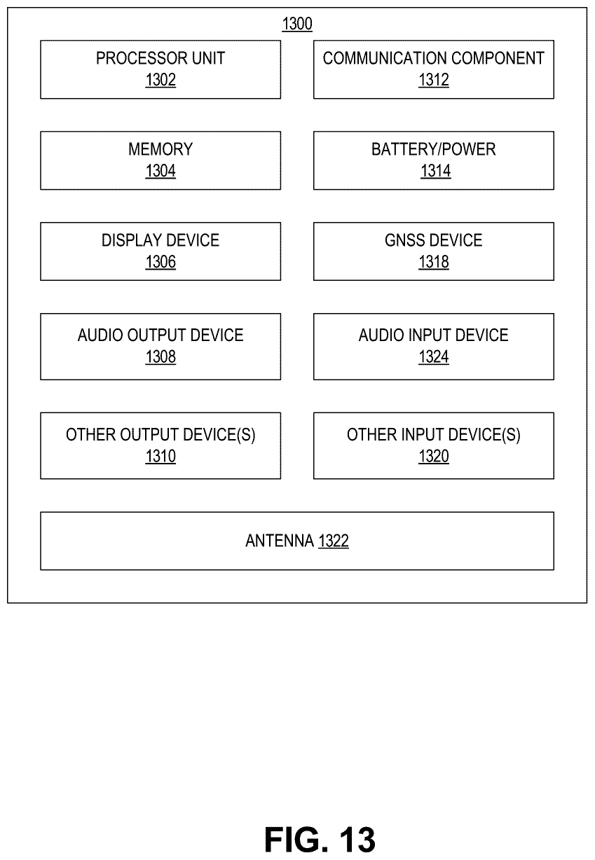

FIG. 10 is a top view of a wafer 1000 and dies 1002 that may be included in any of the embodiments disclosed herein. The wafer 1000 may be composed of semiconductor material and may include one or more dies 1002 having integrated circuit structures formed on a surface of the wafer 1000. The individual dies 1002 may be a repeating unit of an integrated circuit product that includes any suitable integrated circuit. After the fabrication of the semiconductor product is complete, the wafer 1000 may undergo a singulation process in which the dies 1002 are separated from one another to provide discrete “chips” of the integrated circuit product. The die 1002 may be any of the dies disclosed herein. The die 1002 may include one or more transistors (e.g., some of the transistors 1140 of FIG. 11, discussed below), supporting circuitry to route electrical signals to the transistors, passive components (e.g., signal traces, resistors, capacitors, or inductors), and/or any other integrated circuit components. In some embodiments, the wafer 1000 or the die 1002 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1002. For example, a memory array formed by multiple memory devices may be formed on a same die 1002 as a processor unit (e.g., the processor unit 1302 of FIG. 13) or other logic that is configured to store information in the memory devices or execute instructions stored in the memory array. Various ones of the microelectronic assemblies disclosed herein may be manufactured using a die-to-wafer assembly technique in which some dies are attached to a wafer 1000 that include others of the dies, and the wafer 1000 is subsequently singulated.

FIG. 11 is a cross-sectional side view of an integrated circuit device 1100 that may be included in any of the embodiments disclosed herein (e.g., in any of the dies, such as PICS 110, 904, EIC 906, XPU 908). One or more of the integrated circuit devices 1100 may be included in one or more dies 1002 (FIG. 10). The integrated circuit device 1100 may be formed on a die substrate 1102 (e.g., the wafer 1000 of FIG. 10) and may be included in a die (e.g., the die 1002 of FIG. 10). The die substrate 1102 may be a semiconductor substrate composed of semiconductor material systems including, for example, n-type or p-type materials systems (or a combination of both). The die substrate 1102 may include, for example, a crystalline substrate formed using a bulk silicon or a silicon-on-insulator (SOI) substructure. In some embodiments, the die substrate 1102 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1102. Although a few examples of materials from which the die substrate 1102 may be formed are described here, any material that may serve as a foundation for an integrated circuit device 1100 may be used. The die substrate 1102 may be part of a singulated die (e.g., the dies 1002 of FIG. 10) or a wafer (e.g., the wafer 1000 of FIG. 10).

The integrated circuit device 1100 may include one or more device layers 1104 disposed on the die substrate 1102. The device layer 1104 may include features of one or more transistors 1140 (e.g., metal oxide semiconductor field-effect transistors (MOSFETs)) formed on the die substrate 1102. The transistors 1140 may include, for example, one or more source and/or drain (S/D) regions 1120, a gate 1122 to control current flow between the S/D regions 1120, and one or more S/D contacts 1124 to route electrical signals to/from the S/D regions 1120. The transistors 1140 may include additional features not depicted for the sake of clarity, such as device isolation regions, gate contacts, and the like. The transistors 1140 are not limited to the type and configuration depicted in FIG. 11 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

Returning to FIG. 11, a transistor 1140 may include a gate 1122 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1140 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1140 along the source-channel-drain direction, the gate electrode may consist of a U-shaped structure that includes a bottom portion substantially parallel to the surface of the die substrate 1102 and two sidewall portions that are substantially perpendicular to the top surface of the die substrate 1102. In other embodiments, at least one of the metal layers that form the gate electrode may simply be a planar layer that is substantially parallel to the top surface of the die substrate 1102 and does not include sidewall portions substantially perpendicular to the top surface of the die substrate 1102. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1120 may be formed within the die substrate 1102 adjacent to the gate 1122 of individual transistors 1140. The S/D regions 1120 may be formed using an implantation/diffusion process or an etching/deposition process, for example. In the former process, dopants such as boron, aluminum, antimony, phosphorous, or arsenic may be ion-implanted into the die substrate 1102 to form the S/D regions 1120. An annealing process that activates the dopants and causes them to diffuse farther into the die substrate 1102 may follow the ion-implantation process. In the latter process, the die substrate 1102 may first be etched to form recesses at the locations of the S/D regions 1120. An epitaxial deposition process may then be carried out to fill the recesses with material that is used to fabricate the S/D regions 1120. In some implementations, the S/D regions 1120 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1120 may be formed using one or more alternate semiconductor materials such as germanium or a group III-V material or alloy. In further embodiments, one or more layers of metal and/or metal alloys may be used to form the S/D regions 1120.

Electrical signals, such as power and/or input/output (I/O) signals, may be routed to and/or from the devices (e.g., transistors 1140) of the device layer 1104 through one or more interconnect layers disposed on the device layer 1104 (illustrated in FIG. 11 as interconnect layers 1106-1110). For example, electrically conductive features of the device layer 1104 (e.g., the gate 1122 and the S/D contacts 1124) may be electrically coupled with the interconnect structures 1128 of the interconnect layers 1106-1110. The one or more interconnect layers 1106-1110 may form a metallization stack (also referred to as an “ILD stack”) 1119 of the integrated circuit device 1100.

The interconnect structures 1128 may be arranged within the interconnect layers 1106-1110 to route electrical signals according to a wide variety of designs; in particular, the arrangement is not limited to the particular configuration of interconnect structures 1128 depicted in FIG. 11. Although a particular number of interconnect layers 1106-1110 is depicted in FIG. 11, embodiments of the present disclosure include integrated circuit devices having more or fewer interconnect layers than depicted.

In some embodiments, the interconnect structures 1128 may include lines 1128a and/or vias 1128b filled with an electrically conductive material such as a metal. The lines 1128a may be arranged to route electrical signals in a direction of a plane that is substantially parallel with a surface of the die substrate 1102 upon which the device layer 1104 is formed. For example, the lines 1128a may route electrical signals in a direction in and out of the page and/or in a direction across the page from the perspective of FIG. 11. The vias 1128b may be arranged to route electrical signals in a direction of a plane that is substantially perpendicular to the surface of the die substrate 1102 upon which the device layer 1104 is formed. In some embodiments, the vias 1128b may electrically couple lines 1128a of different interconnect layers 1106-1110 together.

The interconnect layers 1106-1110 may include a dielectric material 1126 disposed between the interconnect structures 1128, as shown in FIG. 11. In some embodiments, dielectric material 1126 disposed between the interconnect structures 1128 in different ones of the interconnect layers 1106-1110 may have different compositions; in other embodiments, the composition of the dielectric material 1126 between different interconnect layers 1106-1110 may be the same. The device layer 1104 may include a dielectric material 1126 disposed between the transistors 1140 and a bottom layer of the metallization stack as well. The dielectric material 1126 included in the device layer 1104 may have a different composition than the dielectric material 1126 included in the interconnect layers 1106-1110; in other embodiments, the composition of the dielectric material 1126 in the device layer 1104 may be the same as a dielectric material 1126 included in any one of the interconnect layers 1106-1110.

A first interconnect layer 1106 (referred to as Metal 1 or “M1”) may be formed directly on the device layer 1104. In some embodiments, the first interconnect layer 1106 may include lines 1128a and/or vias 1128b, as shown. The lines 1128a of the first interconnect layer 1106 may be coupled with contacts (e.g., the S/D contacts 1124) of the device layer 1104. The vias 1128b of the first interconnect layer 1106 may be coupled with the lines 1128a of a second interconnect layer 1108.

The second interconnect layer 1108 (referred to as Metal 2 or “M2”) may be formed directly on the first interconnect layer 1106. In some embodiments, the second interconnect layer 1108 may include via 1128b to couple the lines 1128 of the second interconnect layer 1108 with the lines 1128a of a third interconnect layer 1110. Although the lines 1128a and the vias 1128b are structurally delineated with a line within individual interconnect layers for the sake of clarity, the lines 1128a and the vias 1128b may be structurally and/or materially contiguous (e.g., simultaneously filled during a dual-damascene process) in some embodiments.

The third interconnect layer 1110 (referred to as Metal 3 or “M3”) (and additional interconnect layers, as desired) may be formed in succession on the second interconnect layer 1108 according to similar techniques and configurations described in connection with the second interconnect layer 1108 or the first interconnect layer 1106. In some embodiments, the interconnect layers that are “higher up” in the metallization stack 1119 in the integrated circuit device 1100 (i.e., farther away from the device layer 1104) may be thicker that the interconnect layers that are lower in the metallization stack 1119, with lines 1128a and vias 1128b in the higher interconnect layers being thicker than those in the lower interconnect layers.

The integrated circuit device 1100 may include a solder resist material 1134 (e.g., polyimide or similar material) and one or more conductive contacts 1136 formed on the interconnect layers 1106-1110. In FIG. 11, the conductive contacts 1136 are illustrated as taking the form of bond pads. The conductive contacts 1136 may be electrically coupled with the interconnect structures 1128 and configured to route the electrical signals of the transistor(s) 1140 to external devices. For example, solder bonds may be formed on the one or more conductive contacts 1136 to mechanically and/or electrically couple an integrated circuit die including the integrated circuit device 1100 with another component (e.g., a printed circuit board). The integrated circuit device 1100 may include additional or alternate structures to route the electrical signals from the interconnect layers 1106-1110; for example, the conductive contacts 1136 may include other analogous features (e.g., posts) that route the electrical signals to external components. The conductive contacts 1136 may serve as any of the conductive contacts described throughout this disclosure.

In some embodiments in which the integrated circuit device 1100 is a double-sided die, the integrated circuit device 1100 may include another metallization stack (not shown) on the opposite side of the device layer(s) 1104. This metallization stack may include multiple interconnect layers as discussed above with reference to the interconnect layers 1106-1110, to provide conductive pathways (e.g., including conductive lines and vias) between the device layer(s) 1104 and additional conductive contacts (not shown) on the opposite side of the integrated circuit device 1100 from the conductive contacts 1136. These additional conductive contacts may serve as any of the conductive contacts described throughout this disclosure.

In other embodiments in which the integrated circuit device 1100 is a double-sided die, the integrated circuit device 1100 may include one or more through silicon vias (TSVs) through the die substrate 1102; these TSVs may make contact with the device layer(s) 1104, and may provide conductive pathways between the device layer(s) 1104 and additional conductive contacts (not shown) on the opposite side of the integrated circuit device 1100 from the conductive contacts 1136. These additional conductive contacts may serve as any of the conductive contacts described throughout this disclosure. In some embodiments, TSVs extending through the substrate can be used for routing power and ground signals from conductive contacts on the opposite side of the integrated circuit device 1100 from the conductive contacts 1136 to the transistors 1140 and any other components integrated into the die 1100, and the metallization stack 1119 can be used to route I/O signals from the conductive contacts 1136 to transistors 1140 and any other components integrated into the die 1100.

Multiple integrated circuit devices 1100 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

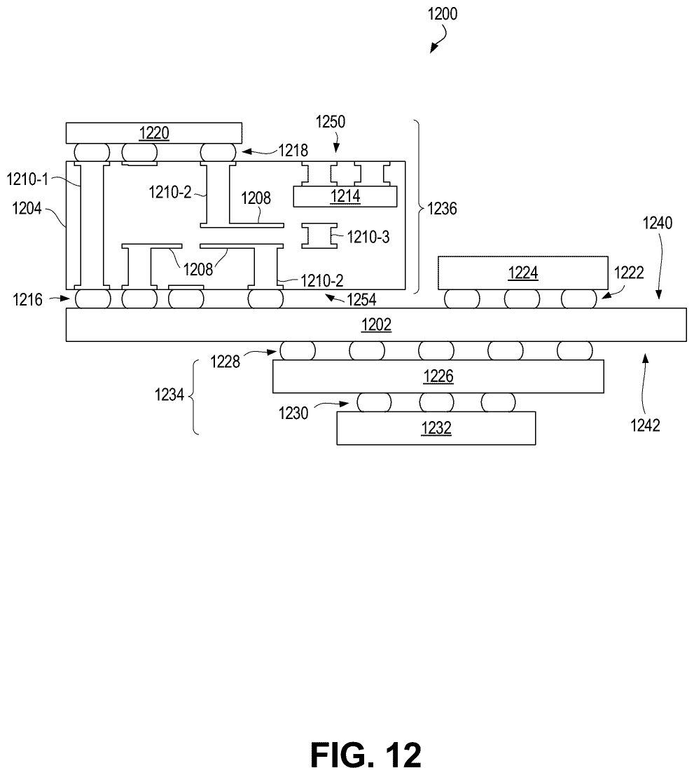

FIG. 12 is a cross-sectional side view of an integrated circuit device assembly 1200 that may include any of the embodiments disclosed herein (e.g., optical connections 100, 500, optical adapters/holders 130, 140, 200, 300, 400, 530, 540, 600, 700, 915, optical cables 120, 510, 520, 920, optical couplers 112, 912, PICs 110, 904, EIC 906, optical interface 910, optical package 900). In some embodiments, the integrated circuit device assembly 1200 may be a microelectronic assembly. The integrated circuit device assembly 1200 includes a number of components disposed on a circuit board 1202 (which may be a motherboard, system board, mainboard, etc.). The integrated circuit device assembly 1200 includes components disposed on a first face 1240 of the circuit board 1202 and an opposing second face 1242 of the circuit board 1202; generally, components may be disposed on one or both faces 1240 and 1242. Any of the integrated circuit components discussed below with reference to the integrated circuit device assembly 1200 may take the form of any suitable ones of the embodiments of the microelectronic assemblies disclosed herein.

In some embodiments, the circuit board 1202 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1202. In other embodiments, the circuit board 1202 may be a non-PCB substrate. The integrated circuit device assembly 1200 illustrated in FIG. 12 includes a package-on-interposer structure 1236 coupled to the first face 1240 of the circuit board 1202 by coupling components 1216. The coupling components 1216 may electrically and mechanically couple the package-on-interposer structure 1236 to the circuit board 1202, and may include solder balls (as shown in FIG. 12), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1216 may serve as the coupling components illustrated or described for any of the substrate assembly or substrate assembly components described herein, as appropriate.

The package-on-interposer structure 1236 may include an integrated circuit component 1220 coupled to an interposer 1204 by coupling components 1218. The coupling components 1218 may take any suitable form for the application, such as the forms discussed above with reference to the coupling components 1216. Although a single integrated circuit component 1220 is shown in FIG. 12, multiple integrated circuit components may be coupled to the interposer 1204; indeed, additional interposers may be coupled to the interposer 1204. The interposer 1204 may provide an intervening substrate used to bridge the circuit board 1202 and the integrated circuit component 1220.

The integrated circuit component 1220 may be a packaged or unpacked integrated circuit product that includes one or more integrated circuit dies (e.g., the die 1002 of FIG. 10, the integrated circuit device 1100 of FIG. 11) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1220, a single monolithic integrated circuit die comprises solder bumps attached to contacts on the die. The solder bumps allow the die to be directly attached to the interposer 1204. The integrated circuit component 1220 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1220 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1220 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1220 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1204 may spread connections to a wider pitch or reroute a connection to a different connection. For example, the interposer 1204 may couple the integrated circuit component 1220 to a set of ball grid array (BGA) conductive contacts of the coupling components 1216 for coupling to the circuit board 1202. In the embodiment illustrated in FIG. 12, the integrated circuit component 1220 and the circuit board 1202 are attached to opposing sides of the interposer 1204; in other embodiments, the integrated circuit component 1220 and the circuit board 1202 may be attached to a same side of the interposer 1204. In some embodiments, three or more components may be interconnected by way of the interposer 1204.

In some embodiments, the interposer 1204 may be formed as a PCB, including multiple metal layers separated from one another by layers of dielectric material and interconnected by electrically conductive vias. In some embodiments, the interposer 1204 may be formed of an epoxy resin, a fiberglass-reinforced epoxy resin, an epoxy resin with inorganic fillers, a ceramic material, or a polymer material such as polyimide. In some embodiments, the interposer 1204 may be formed of alternate rigid or flexible materials that may include the same materials described above for use in a semiconductor substrate, such as silicon, germanium, and other group III-V and group IV materials. The interposer 1204 may include metal interconnects 1208 and vias 1210, including but not limited to through hole vias 1210-1 (that extend from a first face 1250 of the interposer 1204 to a second face 1254 of the interposer 1204), blind vias 1210-2 (that extend from the first or second faces 1250 or 1254 of the interposer 1204 to an internal metal layer), and buried vias 1210-3 (that connect internal metal layers).

In some embodiments, the interposer 1204 can comprise a silicon interposer. Through silicon vias (TSV) extending through the silicon interposer can connect connections on a first face of a silicon interposer to an opposing second face of the silicon interposer. In some embodiments, an interposer 1204 comprising a silicon interposer can further comprise one or more routing layers to route connections on a first face of the interposer 1204 to an opposing second face of the interposer 1204.

The interposer 1204 may further include embedded devices 1214, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1204. The package-on-interposer structure 1236 may take the form of any of the package-on-interposer structures known in the art. In embodiments where the interposer is a non-printed circuit board

The integrated circuit device assembly 1200 may include an integrated circuit component 1224 coupled to the first face 1240 of the circuit board 1202 by coupling components 1222. The coupling components 1222 may take the form of any of the embodiments discussed above with reference to the coupling components 1216, and the integrated circuit component 1224 may take the form of any of the embodiments discussed above with reference to the integrated circuit component 1220.

The integrated circuit device assembly 1200 illustrated in FIG. 12 includes a package-on-package structure 1234 coupled to the second face 1242 of the circuit board 1202 by coupling components 1228. The package-on-package structure 1234 may include an integrated circuit component 1226 and an integrated circuit component 1232 coupled together by coupling components 1230 such that the integrated circuit component 1226 is disposed between the circuit board 1202 and the integrated circuit component 1232. The coupling components 1228 and 1230 may take the form of any of the embodiments of the coupling components 1216 discussed above, and the integrated circuit components 1226 and 1232 may take the form of any of the embodiments of the integrated circuit component 1220 discussed above. The package-on-package structure 1234 may be configured in accordance with any of the package-on-package structures known in the art.

FIG. 13 is a block diagram of an example electronic device 1300 that may include one or more of the embodiments disclosed herein. For example, any suitable ones of the components of the electronic device 1300 may include one or more of the optical connections 100, 500, optical adapters/holders 130, 140, 200, 300, 400, 530, 540, 600, 700, 915, optical cables 120, 510, 520, 920, optical couplers 112, 912, PICs 110, 904, EIC 906, optical interface 910, optical package 900, integrated circuit device assemblies 1200, integrated circuit components 1220, integrated circuit devices 1100, or integrated circuit dies 1002 disclosed herein. In some embodiments, for example, the electronic device 1300 and/or its respective components (e.g., processor units 1302, input/output (I/O) devices 1310, 1320, communication components 1312, memory 1304) may include an optical interface for optical communication according to any of the embodiments described herein. A number of components are illustrated in FIG. 13 as included in the electronic device 1300, but any one or more of these components may be omitted or duplicated, as suitable for the application. In some embodiments, some or all of the components included in the electronic device 1300 may be attached to one or more motherboards mainboards, or system boards. In some embodiments, one or more of these components are fabricated onto a single system-on-a-chip (SoC) die.

Additionally, in various embodiments, the electronic device 1300 may not include one or more of the components illustrated in FIG. 13, but the electronic device 1300 may include interface circuitry for coupling to the one or more components. For example, the electronic device 1300 may not include a display device 1306, but may include display device interface circuitry (e.g., a connector and driver circuitry) to which a display device 1306 may be coupled. In another set of examples, the electronic device 1300 may not include an audio input device 1324 or an audio output device 1308, but may include audio input or output device interface circuitry (e.g., connectors and supporting circuitry) to which an audio input device 1324 or audio output device 1308 may be coupled.

The electronic device 1300 may include one or more processor units 1302 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1302 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electronic device 1300 may include a memory 1304, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1304 may include memory that is located on the same integrated circuit die as the processor unit 1302. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electronic device 1300 can comprise one or more processor units 1302 that are heterogeneous or asymmetric to another processor unit 1302 in the electronic device 1300. There can be a variety of differences between the processing units 1302 in a system in terms of a spectrum of metrics of merit including architectural, microarchitectural, thermal, power consumption characteristics, and the like. These differences can effectively manifest themselves as asymmetry and heterogeneity among the processor units 1302 in the electronic device 1300.

In some embodiments, the electronic device 1300 may include a communication component 1312 (e.g., one or more communication components). For example, the communication component 1312 can manage wireless communications for the transfer of data to and from the electronic device 1300. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1312 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1312 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1312 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1312 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1312 may operate in accordance with other wireless protocols in other embodiments. The electronic device 1300 may include an antenna 1322 to facilitate wireless communications and/or to receive other wireless communications (such as AM or FM radio transmissions).

In some embodiments, the communication component 1312 may manage wired communications, such as electrical, optical, or any other suitable communication protocols (e.g., IEEE 802.3 Ethernet standards). As noted above, the communication component 1312 may include multiple communication components. For instance, a first communication component 1312 may be dedicated to shorter-range wireless communications such as Wi-Fi or Bluetooth, and a second communication component 1312 may be dedicated to longer-range wireless communications such as global positioning system (GPS), EDGE, GPRS, CDMA, WiMAX, LTE, EV-DO, or others. In some embodiments, a first communication component 1312 may be dedicated to wireless communications, and a second communication component 1312 may be dedicated to wired communications.

The electronic device 1300 may include battery/power circuitry 1314. The battery/power circuitry 1314 may include one or more energy storage devices (e.g., batteries or capacitors) and/or circuitry for coupling components of the electronic device 1300 to an energy source separate from the electronic device 1300 (e.g., AC line power).

The electronic device 1300 may include a display device 1306 (or corresponding interface circuitry, as discussed above). The display device 1306 may include one or more embedded or wired or wirelessly connected external visual indicators, such as a heads-up display, a computer monitor, a projector, a touchscreen display, a liquid crystal display (LCD), a light-emitting diode display, or a flat panel display.

The electronic device 1300 may include an audio output device 1308 (or corresponding interface circuitry, as discussed above). The audio output device 1308 may include any embedded or wired or wirelessly connected external device that generates an audible indicator, such speakers, headsets, or earbuds.

The electronic device 1300 may include an audio input device 1324 (or corresponding interface circuitry, as discussed above). The audio input device 1324 may include any embedded or wired or wirelessly connected device that generates a signal representative of a sound, such as microphones, microphone arrays, or digital instruments (e.g., instruments having a musical instrument digital interface (MIDI) output). The electronic device 1300 may include a Global Navigation Satellite System (GNSS) device 1318 (or corresponding interface circuitry, as discussed above), such as a Global Positioning System (GPS) device. The GNSS device 1318 may be in communication with a satellite-based system and may determine a geolocation of the electronic device 1300 based on information received from one or more GNSS satellites, as known in the art.

The electronic device 1300 may include other output device(s) 1310 (or corresponding interface circuitry, as discussed above). Examples of the other output device(s) 1310 may include an audio codec, a video codec, a printer, a wired or wireless transmitter for providing information to other devices, or an additional storage device.

The electronic device 1300 may include other input device(s) 1320 (or corresponding interface circuitry, as discussed above). Examples of the other input device(s) 1320 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electronic device 1300 may have any desired form factor, such as a hand-held or mobile electronic device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electronic device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electronic device or an embedded computing system (e.g., computing systems that are part of a vehicle, smart home appliance, consumer electronics product or equipment, manufacturing equipment). In some embodiments, the electronic device 1300 may be any other electrical or electronic device that processes data. In some embodiments, the electronic device 1300 may comprise multiple discrete physical components. Given the range of devices that the electronic device 1300 can be manifested as in various embodiments, in some embodiments, the electronic device 1300 can be referred to as a computing device or a computing system.

### Examples

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes an optical adapter, comprising: a first interface to mate with a first optical connector, wherein the first interface comprises a first set of alignment features to align the optical adapter with the first optical connector; a second interface to mate with a second optical connector, wherein the second interface comprises a second set of alignment features to align the optical adapter with the second optical connector, wherein the first and second optical connectors are not designed to mate with each other; and a plurality of waveguides extending through the optical adapter from the first interface to the second interface, wherein when the first interface is mated with the first optical connector and the second interface is mated with the second optical connector, the first and second optical connectors are optically coupled via the plurality of waveguides.

Example 2 includes the optical adapter of Example 1, further comprising: an adapter, wherein the adapter comprises the first interface, the second interface, and the plurality of waveguides; and an adapter holder to hold the adapter.

Example 3 includes the optical adapter of Example 2, wherein the adapter holder is further to align the first and second optical connectors to the first and second interfaces of the adapter.

Example 4 includes the optical adapter of Example 1, further comprising a glass interposer, wherein the glass interposer comprises the first interface, the second interface, and the plurality of waveguides, wherein the first interface is at a first end of the glass interposer and the second interface is at a second end of the glass interposer, and wherein the plurality of waveguides extend through the glass interposer from the first interface to the second interface.

Example 5 includes the optical adapter of any of Examples 1-4, wherein: the first set of alignment features are further to align the waveguides in the optical adapter with waveguides in the first optical connector; and the second set of alignment features are further to align the waveguides in the optical adapter with waveguides in the second optical connector.

Example 6 includes the optical adapter of any of Examples 1-5, wherein: the first optical connector is an optical socket on an integrated circuit package; and the second optical connector is an optical plug on an optical cable.

Example 7 includes the optical adapter of Example 6, wherein: the integrated circuit package comprises the optical socket and a photonic integrated circuit (PIC), wherein the optical socket is coupled to the PIC; and the optical cable comprises the optical plug and a plurality of optical fibers, wherein the optical plug is coupled to the plurality of optical fibers.

Example 8 includes the optical adapter of any of Examples 6-7, wherein the optical plug comprises a mechanical transfer (MT) ferrule.

Example 9 includes the optical adapter of any of Examples 1-5, wherein: the first optical connector is a first optical plug on a first optical cable; and the second optical connector is a second optical plug on a second optical cable.

Example 10 includes the optical adapter of Example 9, wherein: the first optical plug comprises a glass ferrule; and the second optical plug comprises a mechanical transfer (MT) ferrule.

Example 11 includes an optical adapter assembly, comprising: an adapter to optically couple a first optical connector and a second optical connector, wherein the first and second optical connectors are not designed to mate with each other; and an adapter holder to hold the adapter and align the first and second optical connectors to the adapter.

Example 12 includes the optical adapter assembly of Example 11, wherein the adapter comprises: a first interface to mate with the first optical connector, wherein the first interface is at a first end of the adapter; a second interface to mate with the second optical connector, wherein the second interface is at a second end of the adapter; and a plurality of waveguides extending between the first interface and the second interface, wherein when the first interface is mated with the first optical connector and the second interface is mated with the second optical connector, the first and second optical connectors are optically coupled via the plurality of waveguides.

Example 13 includes the optical adapter assembly of Example 12, wherein: the first interface comprises a first set of alignment features to align the waveguides in the adapter with waveguides in the first optical connector; and the second interface comprises a second set of alignment features to align the waveguides in the adapter with waveguides in the second optical connector.

Example 14 includes the optical adapter assembly of any of Examples 11-13, wherein the adapter is at least partially made of glass.

Example 15 includes the optical adapter assembly of any of Examples 12-14, wherein the adapter holder comprises: a cavity to hold the adapter; a first set of alignment features to align the first optical connector to the first interface of the adapter; and a second set of alignment features to align the second optical connector to the second interface of the adapter.

Example 16 includes the optical adapter assembly of any of Examples 11-15, wherein the first optical connector and the second optical connector respectively comprise: an optical socket on an integrated circuit package; or an optical plug on an optical cable.

Example 17 includes a system, comprising: an integrated circuit package comprising an optical socket; an optical cable, wherein the optical cable comprises an optical plug and a plurality of optical fibers coupled to the optical plug; and an optical adapter to optically couple the optical socket and the optical plug, wherein the optical socket and the optical plug are not designed to mate with each other, and wherein the optical adapter comprises: a first interface to mate with the optical socket; a second interface to mate with the optical plug; and a plurality of waveguides extending through the optical adapter from the first interface to the second interface, wherein when the first interface is mated with the optical socket and the second interface is mated with the optical plug, the optical socket and the optical plug are optically coupled via the plurality of waveguides.

Example 18 includes the system of Example 17, wherein: the first interface comprises a first set of alignment features to align the waveguides in the optical adapter with waveguides in the optical socket; and the second interface comprises a second set of alignment features to align the waveguides in the optical adapter with waveguides in the optical plug.

Example 19 includes the system of any of Examples 17-18, wherein the optical plug comprises a mechanical transfer (MT) ferrule.

Example 20 includes the system of any of Examples 17-19, wherein the integrated circuit package further comprises a photonic integrated circuit to send or receive optical signals via the optical socket.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. Further, it should be understood that the various embodiments shown in the figures are illustrative representations and are not necessarily drawn to scale.

Moreover, the illustrations and/or descriptions of various embodiments may be simplified or approximated for ease of understanding, and as a result, they may not necessarily reflect the level of precision nor variation that may be present in actual embodiments. For example, while some figures generally indicate straight lines, right angles, and smooth surfaces, actual implementations of the disclosed embodiments may have less than perfect straight lines and right angles, and some features may have surface topography or otherwise be non-smooth, given real-world limitations of fabrication processes. Similarly, illustrations and/or descriptions of how components are arranged may be simplified or approximated for ease of understanding and may vary by some margin of error in actual embodiments (e.g., due to fabrication processes, etc.).

Unless otherwise specified, the use of the ordinal adjectives “first,” “second,” and “third,” etc., to describe a common object, merely indicate that different instances of like objects to which are being referred and are not intended to imply that the objects so described must be in a given sequence, either temporally, spatially, in ranking or in any other manner.

The terms “substantially,” “close,” “approximately,” “near,” and “about,” generally refer to being within +/−10% of a target value (unless otherwise specified). Similarly, terms describing spatial relationships, such as “perpendicular,” “orthogonal,” or “coplanar,” may refer to being substantially within the described spatial relationships (e.g., within +/−10 degrees of orthogonality).

Certain terminology may also be used in the foregoing description for the purpose of reference only, and thus are not intended to be limiting. For example, terms such as “upper,” “lower,” “above,” “below,” “bottom,” and “top” refer to directions in the drawings to which reference is made. Terms such as “front,” “back,” “rear,” and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

The terms “over”, “between”, “adjacent”, “to”, and “on” as used herein may refer to a relative position of one layer or component with respect to other layers or components. For example, one layer “over” or “on” another layer, “adjacent” to another layer, or bonded “to” another layer may be directly in contact with the other layer or may have one or more intervening layers. One layer “between” layers may be directly in contact with the layers or may have one or more intervening layers.

The meaning of “a,” “an,” and “the” include plural references. The meaning of “in” includes “in” and “on.”

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

Views labeled “cross-sectional”, “profile” and “plan” correspond to orthogonal planes within a cartesian coordinate system. Thus, cross-sectional and profile views are taken in the x-z plane, and plan views are taken in the x-y plane. Typically, profile views in the x-z plane are cross-sectional views. Where appropriate, drawings are labeled with axes to indicate the orientation of the figure.

The term “package” generally refers to a self-contained carrier of one or more dice, where the dice are attached to the package substrate, and may be encapsulated for protection, with integrated or wire-bonded interconnects between the dice and leads, pins or bumps located on the external portions of the package substrate. The package may contain a single die, or multiple dice, providing a specific function. The package is usually mounted on a printed circuit board for interconnection with other packaged integrated circuits and discrete components, forming a larger circuit.

The term “cored” generally refers to a substrate of an integrated circuit package built upon a board, card or wafer comprising a non-flexible stiff material. Typically, a small printed circuit board is used as a core, upon which integrated circuit device and discrete passive components may be soldered. Typically, the core has vias extending from one side to the other, allowing circuitry on one side of the core to be coupled directly to circuitry on the opposite side of the core. The core may also serve as a platform for building up layers of conductors and dielectric materials.

The term “coreless” generally refers to a substrate of an integrated circuit package having no core. The lack of a core allows for higher-density package architectures, as the through-vias have relatively large dimensions and pitch compared to high-density interconnects.

The term “land side”, if used herein, generally refers to the side of the substrate of the integrated circuit package closest to the plane of attachment to a printed circuit board, motherboard, or other package. This is in contrast to the term “die side”, which is the side of the substrate of the integrated circuit package to which the die or dice are attached.

The term “dielectric” generally refers to any number of non-electrically conductive materials that make up the structure of a package substrate. For purposes of this disclosure, dielectric material may be incorporated into an integrated circuit package as layers of laminate film or as a resin molded over integrated circuit dice mounted on the substrate.

The term “metallization” generally refers to metal layers formed over and through the dielectric material of the package substrate. The metal layers are generally patterned to form metal structures such as traces and bond pads. The metallization of a package substrate may be confined to a single layer or in multiple layers separated by layers of dielectric.

The term “bond pad” generally refers to metallization structures that terminate integrated traces and vias in integrated circuit packages and dies. The term “solder pad” may be occasionally substituted for “bond pad” and carries the same meaning.

The term “solder bump” generally refers to a solder layer formed on a bond pad. The solder layer typically has a round shape, hence the term “solder bump”.

The term “substrate” generally refers to a planar platform comprising dielectric and/or metallization structures. The substrate may mechanically support and electrically couple one or more IC dies on a single platform, with encapsulation of the one or more IC dies by a moldable dielectric material. The substrate generally comprises solder bumps as bonding interconnects on both sides. One side of the substrate, generally referred to as the “die side”, may comprise solder bumps for chip or die bonding. The opposite side of the substrate, generally referred to as the “land side”, may comprise solder bumps for bonding the package to a printed circuit board.

The term “assembly” generally refers to a grouping of parts into a single functional unit. The parts may be separate and are mechanically assembled into a functional unit, where the parts may be removable. In another instance, the parts may be permanently bonded together. In some instances, the parts are integrated together.

The terms “coupled” or “connected” means a direct or indirect connection, such as a direct electrical, mechanical, magnetic or fluidic connection between the things that are connected or an indirect connection, through one or more passive or active intermediary devices.

The term “circuit” or “module” may refer to one or more passive and/or active components that are arranged to cooperate with one another to provide a desired function. The term “signal” may refer to at least one current signal, voltage signal, magnetic signal, or data/clock signal.

1. An optical adapter, comprising:
a first interface to mate with a first optical connector, wherein the first interface comprises a first set of alignment features to align the optical adapter with the first optical connector;
a second interface to mate with a second optical connector, wherein the second interface comprises a second set of alignment features to align the optical adapter with the second optical connector, wherein the first and second optical connectors are not designed to mate with each other; and
a plurality of waveguides extending through the optical adapter from the first interface to the second interface, wherein when the first interface is mated with the first optical connector and the second interface is mated with the second optical connector, the first and second optical connectors are optically coupled via the plurality of waveguides.

2. The optical adapter of claim 1, further comprising:
an adapter, wherein the adapter comprises the first interface, the second interface, and the plurality of waveguides; and
an adapter holder to hold the adapter.

3. The optical adapter of claim 2, wherein the adapter holder is further to align the first and second optical connectors to the first and second interfaces of the adapter.

4. The optical adapter of claim 1, further comprising a glass interposer, wherein the glass interposer comprises the first interface, the second interface, and the plurality of waveguides, wherein the first interface is at a first end of the glass interposer and the second interface is at a second end of the glass interposer, and wherein the plurality of waveguides extend through the glass interposer from the first interface to the second interface.

5. The optical adapter of claim 1, wherein:
the first set of alignment features are further to align the waveguides in the optical adapter with waveguides in the first optical connector; and
the second set of alignment features are further to align the waveguides in the optical adapter with waveguides in the second optical connector.

6. The optical adapter of claim 1, wherein:
the first optical connector is an optical socket on an integrated circuit package; and
the second optical connector is an optical plug on an optical cable.

7. The optical adapter of claim 6, wherein:
the integrated circuit package comprises the optical socket and a photonic integrated circuit (PIC), wherein the optical socket is coupled to the PIC; and
the optical cable comprises the optical plug and a plurality of optical fibers, wherein the optical plug is coupled to the plurality of optical fibers.

8. The optical adapter of claim 6, wherein the optical plug comprises a mechanical transfer (MT) ferrule.

9. The optical adapter of claim 1, wherein:
the first optical connector is a first optical plug on a first optical cable; and
the second optical connector is a second optical plug on a second optical cable.

10. The optical adapter of claim 9, wherein:
the first optical plug comprises a glass ferrule; and
the second optical plug comprises a mechanical transfer (MT) ferrule.

11. An optical adapter assembly, comprising:
an adapter to optically couple a first optical connector and a second optical connector, wherein the first and second optical connectors are not designed to mate with each other; and
an adapter holder to hold the adapter and align the first and second optical connectors to the adapter.

12. The optical adapter assembly of claim 11, wherein the adapter comprises:
a first interface to mate with the first optical connector, wherein the first interface is at a first end of the adapter;
a second interface to mate with the second optical connector, wherein the second interface is at a second end of the adapter; and
a plurality of waveguides extending between the first interface and the second interface, wherein when the first interface is mated with the first optical connector and the second interface is mated with the second optical connector, the first and second optical connectors are optically coupled via the plurality of waveguides.

13. The optical adapter assembly of claim 12, wherein:
the first interface comprises a first set of alignment features to align the waveguides in the adapter with waveguides in the first optical connector; and
the second interface comprises a second set of alignment features to align the waveguides in the adapter with waveguides in the second optical connector.

14. The optical adapter assembly of claim 12, wherein the adapter is at least partially made of glass.

15. The optical adapter assembly of claim 12, wherein the adapter holder comprises:
a cavity to hold the adapter;
a first set of alignment features to align the first optical connector to the first interface of the adapter; and
a second set of alignment features to align the second optical connector to the second interface of the adapter.

16. The optical adapter assembly of claim 11, wherein the first optical connector and the second optical connector respectively comprise:
an optical socket on an integrated circuit package; or
an optical plug on an optical cable.

17. A system, comprising:
an integrated circuit package comprising an optical socket;
an optical cable, wherein the optical cable comprises an optical plug and a plurality of optical fibers coupled to the optical plug; and
an optical adapter to optically couple the optical socket and the optical plug, wherein the optical socket and the optical plug are not designed to mate with each other, and wherein the optical adapter comprises:
a first interface to mate with the optical socket;
a second interface to mate with the optical plug; and
a plurality of waveguides extending through the optical adapter from the first interface to the second interface, wherein when the first interface is mated with the optical socket and the second interface is mated with the optical plug, the optical socket and the optical plug are optically coupled via the plurality of waveguides.

18. The system of claim 17, wherein:
the first interface comprises a first set of alignment features to align the waveguides in the optical adapter with waveguides in the optical socket; and
the second interface comprises a second set of alignment features to align the waveguides in the optical adapter with waveguides in the optical plug.

19. The system of claim 17, wherein the optical plug comprises a mechanical transfer (MT) ferrule.

20. The system of claim 17, wherein the integrated circuit package further comprises a photonic integrated circuit to send or receive optical signals via the optical socket.
